(19) United States
(12) Patent Application Publication
(10) Pub. No.: US 2009/0180366 A1
(43) Pub. Date: Jul. 16, 2009

(54) OPTICAL DISC RECORDING APPARATUS

(76) Inventors: Akihiro Isaji, Nara (JP); Kazuhiko Nishikawa, Osaka (JP); Hiroyuki Yabuno, Osaka (JP)

Correspondence Address: STEPTOE & JOHNSON LLP, 1330 CONNECTICUT AVE., NW, WASHINGTON, DC, 20036, US

(21) Appl. No.: 12/092,775

(22) PCT Filed: Nov. 6, 2006
(86) PCT No.: PCT/JP2006/322123

§ 371 Date: May 6, 2008

(30) Foreign Application Priority Data
Nov. 7, 2005 (JP) 2005-322667

(51) Int. Cl. G11B 7/12

(52) U.S. Cl. 369/47.53; G9B/7

(57) ABSTRACT

When performing data recording, an output pulse of a laser is measured, and a phase setting of a write strategy is corrected so that the pulse is outputted with a correct phase.

The phase setting of the write strategy is varied in the state where the laser emits a constant power in a laser control system, and an emitted light of a multipulse corresponding to a mark portion of the laser is converted into a voltage by a photodetector, and then averaged by an LPF. Then, a temporal change against the phase setting is measured and detected at a voltage level, and the phase setting of a write strategy generator circuit is corrected and updated so that the measured level becomes an ideal level.

### TECHNICAL FIELD

The present invention relates to apparatuses for recording/reproducing optical information to recordable information storage media.

### BACKGROUND ART

Apparatuses for recording/reproducing information, especially digital information, on/from information storage media have attracted attention as means for recording/reproducing large-volume data. Among them, as for optical information storage media on which data are recorded using laser light, recordable optical information storage media include a write-once optical disc capable of recording only once, and a rewritable phase-change optical disc. In either case, recording to the optical disc is performed by irradiating a rotating disc with a light beam emitted from a semiconductor laser to heat and melt a record film. The achieving temperature of the recording film and the cooling process vary depending on the level of the light beam intensity, and thereby a change occurs in the recording film. Reproduction of the recorded data is performed by irradiating the optical disc with a light beam having a low intensity for reproduction by which the recording film does not change, and change, and reading the recorded data from a difference in intensities of reflected waves which is obtained from a difference in reflectivities of the recording film.

As methods for recording data to optical discs, there are a mark position recording method (or PPM method), and a mark edge recording method (or PWM method), and usually, the mark edge recording method can increase the information recording density relative to the mark position recording method.

In the mark edge recording method, a predetermined mark is recorded by changing positions of a mark start portion and a mark end portion, a recording power, and the like. In recent years, the recording speed has been increased, and there exist various recording media of different materials, different makers, and different standards. In order to deal with these recording media, it is desired to perform setting of optimum mark recording positions for each recording medium in accordance with the recording speed or with considering the type of the recording medium, variations in manufacturing, and the standard.

In the above-mentioned mark edge recording method, when performing mark edge recording of data as a mark on a disc, a write strategy, such as plural pulse sequences called a multipulse or a non-multipulse having no plural pulses, is generated, and optimum recording of a predetermined mark is performed with adjusting this write strategy. When generating such write strategy, a temporal position, i.e., a phase, of the write strategy is set to record the predetermined mark, and high resolution of the phase setting is desired for high-speed recording.

In order to realize an actual optical disc recording/reproduction apparatus, recording pulse conditions for determining a write strategy are recorded in an optical disc recording apparatus or a disc, and it is set such that the recording pulse conditions are recorded with different characteristic parameters for the respective recording media. However, it is considered that the predetermined write strategy setting cannot ensure recording of sufficient quality in a recording medium or a recording apparatus having variations in characteristics.

Against the above-described problems, in Patent Document 1 (or Patent Document 2), plural mark front end pulse conditions and plural mark rear end pulse conditions are shifted, and a value obtained by individually correcting each standard condition so that a jitter obtained when a recording pattern corresponding to each condition is recorded and reproduced becomes equal to or lower than a permissible value is set as a recording pulse condition for a recording/reproduction apparatus to perform recording/reproduction of data.

Further, Patent Document 2 discloses an information recording medium having a specific information recording area for recording specific information of a specific recording apparatus in order to establish an optimum method which increases reliability in optimum recording itself and reduces a search time for optimum positions, with respect to a method for obtaining optimum positions of a mark start port and a mark end portion.

Patent Document 1: Japanese Published Patent Application No. 2000-200418

Patent Document 2: Japanese Published Patent Application No. 2004-281046

### DISCLOSURE OF THE INVENTION

### Problems to be Solved by the Invention

In order to provide an information recording medium and a recording/reproduction apparatus which can perform optimum recording, precision of a write strategy which is outputted as it is set is required. There is a possibility that the time of write strategy or the output in response to the phase setting might be varied depending on the recording apparatus. Further, it is considered that the phase output in response to the setting of write strategy might be abnormal. In these cases, there is a possibility that the conventional method cannot achieve improvement in convergence level of learning or precision of learning, and thereby optimum setting cannot be obtained.

Further, in order to deal with variations in a specific apparatus, a learning algorithm according to the output characteristics of the specific apparatus is required, and therefore, a single learning algorithm cannot be applied to all apparatuses. Furthermore, in order to deal with variations of all apparatuses, learning for obtaining optimum values is complicated, and optimum settings cannot be obtained.

The present invention is made to solve the above-described problems and has for its object to provide an optical disc recording apparatus which can correct an output of an optimum write strategy for setting to perform accurate output even when the output characteristics of the write strategy differ among recording apparatuses, thereby performing optimum recording with suppressing variations in the respective apparatuses.

### Measures to Solve the Problems

In order to solve the above-described problems, according to claim 1 of the present invention, there is provided an optical disc recording apparatus for recording a recording mark on the basis of a write strategy waveform comprising plural pulses, each pulse being shorter than the recording mark, comprising: a write strategy generator circuit for generating the write strategy waveform; a laser light source for emitting a laser light; a laser driving circuit for driving the laser light source according to the pulse sequence of the write strategy waveform; a photodetector for outputting a light intensity of the laser light emitted from the laser light source; a laser power control circuit for controlling the light intensity of the laser light source by controlling the amount of current supplied from the laser driving circuit to the laser light source in accordance with a light intensity signal outputted from the photodetector; an averaging circuit for averaging light intensity signals of a pulse sequence of a mark part, which is outputted from the photodetector, and outputting the result as an averaged level; a sample/hold circuit for sampling and holding the output from the averaging circuit in the mark part; a voltage measurement circuit for measuring the analog level held by the sample/hold circuit as a voltage value; and a phase setting replacement circuit for setting a portion of the write strategy waveform to a multipulse comprising pulses of the same shape being repeated at predetermined intervals, fixing a phase setting of one pulse edge of the multipulse while successively varying a phase setting of the other pulse edge, obtaining an optimum phase setting which minimizes a phase error of pulse edges on a time axis which are actually outputted, on the basis of the measured value of the averaged level obtained by averaging the light intensity signals of the multipulse sequence of the mark part and an ideal value thereof, and changing the predetermined phase setting to the obtained phase setting.

Further, according to claim 2 of the present invention, in the optical disc recording apparatus defined in claim 1, an output period of the multipulse is 1T which is a fundamental period of a mark/space length, the phase setting replacement circuit varies the phase setting of the pulse edge of the multipulse from (r1)T to (r2)T (r1 is a real number within a range of 0≦r1≦1, r2 is a real number within a range of 0≦r2≦1, and r1<r2) to vary the duty ratio of the multipulse from (r1×100) % to (r2×100) %, and the averaging circuit measures the averaged levels corresponding to the respective phase settings.

Further, according to claim 3 of the present invention, in the optical disc recording apparatus defined in claim 2, the phase setting replacement circuit sets the (r1) and (r2) to r1=0 and r2=1, respectively, and varies the phase setting of the pulse edge of the multipulse from 0T to 1T to vary the duty ratio of the multipulse from 0% to 100%, and the averaging circuit measures all the averaged levels which correspond to the respective phase settings.

Further, according to claim 4 of the present invention, in the optical disc recording apparatus defined in claim 1, an output period of the multipulse is 2T which is twice as large as 1T which is a fundamental period of a mark/space length, the phase setting replacement circuit varies the phase setting of the pulse edge of the multipulse from (r3)T to (r3+1)T (r3 is a real number within a range of 0≦r3≦1 to vary the duty ratio of the multipulse from (r3÷2×100) % to (r3+1)÷2×100) %, and the averaging circuit measures the averaged levels corresponding to the respective phase settings.

Further, according to claim 5 of the present invention, in the optical disc recording apparatus defined in claim 4, the phase setting replacement circuit sets the (r3) to r3=0.5, and varies the phase setting of the pulse edge of the multipulse from 0.5T to 1.5T to vary the duty ratio of the multipulse from 25% to 75%, and the averaging circuit measures all the averaged levels which correspond to the respective phase settings.

Further, according to claim 6 of the present invention, in the optical disc recording apparatus defined in claim 1, the phase setting replacement circuit obtains the ideal value by interpolation using a straight line connecting an averaged level (y1) obtained when the duty ratio of the multipulse having the smallest phase setting is (x1) % and an averaged level (y2) obtained when the duty ratio of the multipulse having the largest phase setting is (x2) %, said straight line having an inclination of (y2−y1)÷(x2−x1) and a contact of y1, and compares the ideal value with each measured value of the averaged level of the multipulse sequence obtained for each phase setting, and determines, as the optimum phase setting, the phase setting corresponding to the measured value which is closest to the ideal value, among the respective measured values.

Further, according to claim 7 of the present invention, the optical disc recording apparatus defined in claim 1 further includes a switching circuit for switching an output to the averaging circuit between an output of the photodetector, and an output of a standard signal generation device connected to the optical disc recording apparatus, which outputs a waveform signal equivalent to the write strategy waveform, and the phase setting replacement circuit uses, as the ideal value, the averaged level which is obtained when the switching circuit selects the output of the standard signal generation device, and compares the ideal value with each measured value of the averaged level of the multipulse sequence obtained for each phase setting, which averaged level is obtained when the switching circuit selects the output of the photodetector, and determines, as the optimum phase setting, the phase setting corresponding to the measured value which is closest to the ideal value, among the respective measured values.

Further, according to claim 8 of the present invention, the optical disc recording apparatus defined in claim 6 or 7 further includes a judgment circuit for calculating an error between each measured value and the ideal value, and judges the optical disc recording apparatus as a defective when the error is large.

Further, according to claim 9 of the present invention, in the optical disc recording apparatus defined in claim 1, the phase setting replacement circuit does not perform calculation of the optimum phase setting on a phase setting for which it is difficult to measure a voltage value corresponding to the time width of the duty ratio of the multipulse.

Further, according to claim 10 of the present invention, there is provided an optical disc recording apparatus for recording one recording mark in accordance with a write strategy waveform comprising one block pulse, comprising: a write strategy generator circuit for generating the write strategy waveform; a laser light source for emitting a laser light; a laser driving circuit for driving the laser light source in accordance with a pulse sequence of the write strategy waveform; a photodetector for outputting a light intensity of the laser light emitted from the laser light source; a laser power control circuit for controlling the light intensity of the laser light source by controlling the amount of current supplied from the laser driving circuit to the laser light source in accordance with the light intensity signal outputted from the photodetector; an averaging circuit for averaging light intensity signals of a pulse sequence of a mark part, which is outputted from the photodetector, and outputting the result as an averaged level; a sample/hold circuit for sampling and holding the output of the averaging circuit in the mark part; a voltage measurement circuit for measuring the analog level that is held by the sample/hold circuit, as a voltage value; and a phase setting replacement circuit for setting a portion of the write strategy waveform to a block pulse comprising pulses of the same shape being repeated at predetermined intervals, fixing a phase setting of one pulse edge of the block pulse while successively varying a phase setting of the other pulse edge of the block pulse, fixing a phase setting of one pulse edge of the multipulse while successively varying a phase setting of the other pulse edge of the multipulse, obtaining an optimum phase setting which minimizes a phase error of pulse edges of a time axis that are actually outputted, on the basis of the measured value of the averaged level obtained by averaging the light intensity signals of the multipulse sequence of the mark part and an ideal value thereof, and changing the predetermined phase setting to the obtained phase setting.

Further, according to claim 11 of the present invention, the optical disc recording apparatus defined in claim 1 further includes a hold control circuit for halting the laser control by the laser power control circuit, and a sample position setting circuit for moving a sample position of the averaged level in the sample/hole circuit to a predetermined position, and the laser power control circuit controls the light intensity of the laser light source on the basis of the output of the voltage measurement circuit, the sample position setting circuit moves the sample position to a top pulse portion of the mark part when the laser power control circuit performs laser control, and the sample position setting circuit moves the sample position to a multipulse portion of the mark part and the hold control circuit holds the laser control when the phase setting replacement circuit varies the phase setting.

Further, according to claim 12 of the present invention, the optical disc recording apparatus defined in claim 1 or 10 further includes a voltage gain amplifier for arbitrarily controlling the voltage level of the output signal from the sample/hold circuit.

Further, according to claim 13 of the present invention, in the optical disc recording apparatus defined in claim 1 or 10, the laser power control circuit performs plural times of laser power control with changing the laser emission power level, and controls the light intensity of the laser light source with a laser power having the highest precision of laser power control.

Further, according to claim 14 of the present invention, in the optical disc recording apparatus defined in claim 1 or 10, while focusing onto the optical disc deviates, the phase setting replacement circuit successively varies the phase setting, and the averaging circuit measures the averaged level by averaging the light intensity signal of the multipulse sequence of the mark part for each phase setting.

Further, according to claim 15 of the present invention, in the optical disc recording apparatus defined in claim 1 or 10, the averaging circuit directly averages the pulse signal of the write strategy waveform that is outputted from the write strategy generator circuit, and outputs the result as the averaged level.

Further, according to claim 16 of the present invention, the optical disc recording apparatus defined in claim 15 further includes a switching circuit for switching an output to the averaging circuit between the output of the photodetector and the output of the write strategy generator circuit.

Further, according to claim 17 of the present invention, the optical disc recording apparatus defined in claim 6 or 7 further includes a duty correction circuit for correcting the setting of the duty rate of the multipulse on the basis of the ideal value and the measured value, and the laser power control circuit performs a peak power conversion calculation on the basis of the output of the voltage measurement circuit and the corrected duty ratio.

Further, according to claim 18 of the present invention, the optical disc recording apparatus defined in claim 1 or 10 further includes a nonvolatile memory for holding values of correction parameters that are calculated by the phase setting replacement circuit.

### EFFECTS OF THE INVENTION

According to claim 1 of the present invention, there is provided an optical disc recording apparatus for recording a recording mark on the basis of a write strategy waveform comprising plural pulses, each pulse being shorter than the recording mark, comprising: a write strategy generator circuit for generating the write strategy waveform; a laser light source for emitting a laser light; a laser driving circuit for driving the laser light source according to the pulse sequence of the write strategy waveform; a photodetector for outputting a light intensity of the laser light emitted from the laser light source; a laser power control circuit for controlling the light intensity of the laser light source by controlling the amount of current supplied from the laser driving circuit to the laser light source in accordance with a light intensity signal outputted from the photodetector; an averaging circuit for averaging light intensity signals of a pulse sequence of a mark part, which is outputted from the photodetector, and outputting the result as an averaged level; a sample/hold circuit for sampling and holding the output from the averaging circuit in the mark part; a voltage measurement circuit for measuring the analog level held by the sample/hold circuit as a voltage value; and a phase setting replacement circuit for setting a portion of the write strategy waveform to a multipulse comprising pulses of the same shape being repeated at predetermined intervals, fixing a phase setting of one pulse edge of the multipulse while successively varying a phase setting of the other pulse edge, obtaining an optimum phase setting which minimizes a phase error of pulse edges on a time axis which are actually outputted, on the basis of the measured value of the averaged level obtained by averaging the light intensity signals of the multipulse sequence of the mark part and an ideal value thereof, and changing the predetermined phase setting to the obtained phase setting. Therefore, the phase setting of the write strategy that is actually outputted can be measured at the voltage level, and when an error between the measured value and the ideal value is large, the phase setting can be corrected to a value minimizing the error.

Further, according to claim 2 of the present invention, in the optical disc recording apparatus defined in claim 1, an output period of the multipulse is 1T which is a fundamental period of a mark/space length, the phase setting replacement circuit varies the phase setting of the pulse edge of the multipulse from (r1)T to (r2)T (r1 is a real number within a range of 0≦r1≦1, r2 is a real number within a range of 0≦r2≧1, and r1<r2) to vary the duty ratio of the multipulse from (r1×100) % to (r2×100) %, and the averaging circuit measures the averaged levels corresponding to the respective phase settings. Therefore, the whole 1T as the fundamental period can be measured with the minimum resolution, and when an error between the measured value and the ideal value is large, the phase setting can be corrected to a value minimizing the error.

Further, according to claim 3 of the present invention, in the optical disc recording apparatus defined in claim 2, the phase setting replacement circuit sets the (r1) and (r2) to r1=0 and r2=1, respectively, and varies the phase setting of the pulse edge of the multipulse from 0T to 1T to vary the duty ratio of the multipulse from 0% to 100%, and the averaging circuit measures all the averaged levels which correspond to the respective phase settings. Therefore, the whole 1T as the fundamental period can be measured with the minimum resolution, and when an error between the measured value and the ideal value is large, the phase setting can be corrected to a value minimizing the error.

Further, according to claim 4 of the present invention, in the optical disc recording apparatus defined in claim 1, an output period of the multipulse is 2T which is twice as large as 1T which is a fundamental period of a mark/space length, the phase setting replacement circuit varies the phase setting of the pulse edge of the multipulse from (r3)T to (r3+1)T (r3 is a real number within a range of 0≦r3≦1 to vary the duty ratio of the multipulse from (r3÷2×100) % to (r3+1)÷2×100) %, and the averaging circuit measures the averaged levels corresponding to the respective phase settings. Therefore, even if the rising characteristic and falling characteristic of the laser output characteristics are deteriorated in the vicinity of the setting at which the duty ratio is near 0% or 100% with an increase in the recording speed, when an error between the measured value and the ideal value is large, the phase setting can be corrected to a value minimizing the error.

Further, according to claim 5 of the present invention, in the optical disc recording apparatus defined in claim 4, the phase setting replacement circuit sets the (r3) to r3=0.5, and varies the phase setting of the pulse edge of the multipulse from 0.5T to 1.5T to vary the duty ratio of the multipulse from 25% to 75%, and the averaging circuit measures all the averaged levels which correspond to the respective phase settings. Therefore, even if the rising characteristic and falling characteristic of the laser output characteristics are deteriorated in the vicinity of the setting at which the duty ratio is near 0% or 100% with an increase in the recording speed, the whole 1T as the fundamental period can be measured with the minimum resolution within the range of the duty ratio from 25% to 75%, and when an error between the measured value and the ideal value is large, the phase setting can be corrected to a value minimizing the error.

Further, according to claim 6 of the present invention, in the optical disc recording apparatus defined in claim 1, the phase setting replacement circuit obtains the ideal value by interpolation using a straight line connecting an averaged level (y1) obtained when the duty ratio of the multipulse having the smallest phase setting is (x1) % and an averaged level (y2) obtained when the duty ratio of the multipulse having the largest phase setting is (x2) %, said straight line having an inclination of (y2−y1)÷(x2−x1) and a contact of y1, and compares the ideal value with each measured value of the averaged level of the multipulse sequence obtained for each phase setting, and determines, as the optimum phase setting, the phase setting corresponding to the measured value which is closest to the ideal value, among the respective measured values. Therefore, linear approximation can be performed with two points, i.e., a beginning point of 1T as a fundamental period and a beginning point of next 1T, whereby all the phase settings can be corrected relatively with the minimum resolution of 1T.

Further, according to claim 7 of the present invention, the optical disc recording apparatus defined in claim 1 further includes a switching circuit for switching an output to the averaging circuit between an output of the photodetector, and an output of a standard signal generation device connected to the optical disc recording apparatus, which outputs a waveform signal equivalent to the write strategy waveform, and the phase setting replacement circuit uses, as the ideal value, the averaged level which is obtained when the switching circuit selects the output of the standard signal generation device, and compares the ideal value with each measured value of the averaged level of the multipulse sequence obtained for each phase setting, which averaged level is obtained when the switching circuit selects the output of the photodetector, and determines, as the optimum phase setting, the phase setting corresponding to the measured value which is closest to the ideal value, among the respective measured values. Therefore, the output from the detection system for measuring the average level can be calibrated, resulting in more accurate phase setting correction.

Further, according to claim 8 of the present invention, the optical disc recording apparatus defined in claim 6 or 7 further includes a judgment circuit for calculating an error between each measured value and the ideal value, and judges the optical disc recording apparatus as a defective when the error is large. Therefore, it is possible to perform detection of abnormality in write strategy, and detection of defective recording apparatuses.

Further, according to claim 9 of the present invention, in the optical disc recording apparatus defined in claim 1, the phase setting replacement circuit does not perform calculation of the optimum phase setting on a phase setting for which it is difficult to measure a voltage value corresponding to the time width of the duty ratio of the multipulse. Therefore, it is possible to prevent phase setting that is completely different from the original setting, thereby avoiding abnormal output.

Further, according to claim 10 of the present invention, there is provided an optical disc recording apparatus for recording one recording mark in accordance with a write strategy waveform comprising one block pulse, comprising: a write strategy generator circuit for generating the write strategy waveform; a laser light source for emitting a laser light; a laser driving circuit for driving the laser light source in accordance with a pulse sequence of the write strategy waveform; a photodetector for outputting a light intensity of the laser light emitted from the laser light source; a laser power control circuit for controlling the light intensity of the laser light source by controlling the amount of current supplied from the laser driving circuit to the laser light source in accordance with the light intensity signal outputted from the photodetector; an averaging circuit for averaging light intensity signals of a pulse sequence of a mark part, which is outputted from the photodetector, and outputting the result as an averaged level; a sample/hold circuit for sampling and holding the output of the averaging circuit in the mark part; a voltage measurement circuit for measuring the analog level that is held by the sample/hold circuit, as a voltage value; and a phase setting replacement circuit for setting a portion of the write strategy waveform to a block pulse comprising pulses of the same shape being repeated at predetermined intervals, fixing a phase setting of one pulse edge of the block pulse while successively varying a phase setting of the other pulse edge of the block pulse, fixing a phase setting of one pulse edge of the multipulse while successively varying a phase setting of the other pulse edge of the multipulse, obtaining an optimum phase setting which minimizes a phase error of pulse edges of a time axis that are actually outputted, on the basis of the measured value of the averaged level obtained by averaging the light intensity signals of the multipulse sequence of the mark part and an ideal value thereof, and changing the predetermined phase setting to the obtained phase setting.

Further, according to claim 11 of the present invention, the optical disc recording apparatus defined in claim 1 further includes a hold control circuit for halting the laser control by the laser power control circuit, and a sample position setting circuit for moving a sample position of the averaged level in the sample/hole circuit to a predetermined position, and the laser power control circuit controls the light intensity of the laser light source on the basis of the output of the voltage measurement circuit, the sample position setting circuit moves the sample position to a top pulse portion of the mark part when the laser power control circuit performs laser control, and the sample position setting circuit moves the sample position to a multipulse portion of the mark part and the hold control circuit holds the laser control when the phase setting replacement circuit varies the phase setting. Therefore, the phase error detection system for the write strategy and the phase error detection system for laser control can be commoditized, thereby simplifying the circuit.

Further, according to claim 12 of the present invention, the optical disc recording apparatus defined in claim 1 or 10 further includes a voltage gain amplifier for arbitrarily controlling the voltage level of the output signal from the sample/hold circuit. Therefore, the S/N ratio can be improved by setting an optimum range.

Further, according to claim 13 of the present invention, in the optical disc recording apparatus defined in claim 1 or 10, the laser power control circuit performs plural times of laser power control with changing the laser emission power level, and controls the light intensity of the laser light source with a laser power having the highest precision of laser power control. Therefore, the S/N ratio can be improved by setting an optimum laser power.

Further, according to claim 14 of the present invention, in the optical disc recording apparatus defined in claim 1 or 10, while focusing onto the optical disc deviates, the phase setting replacement circuit successively varies the phase setting, and the averaging circuit measures the averaged level by averaging the light intensity signal of the multipulse sequence of the mark part for each phase setting. Therefore, it is possible to perform correction of the set write strategy and confirmation as to whether the set write strategy is outputted or not, without performing recording onto a recording medium, when the optical disc recording apparatus performs a recording operation.

Further, according to claim 15 of the present invention, in the optical disc recording apparatus defined in claim 1 or 10, the averaging circuit directly averages the pulse signal of the write strategy waveform that is outputted from the write strategy generator circuit, and outputs the result as the averaged level. Therefore, the time signal of the write strategy can be directly converted into a voltage signal, and thereby the phase setting of the write strategy can be corrected even when the laser emission is halted, irrespective of the laser control.

Further, according to claim 16 of the present invention, the optical disc recording apparatus defined in claim 15 further includes a switching circuit for switching an output to the averaging circuit between the output of the photodetector and the output of the write strategy generator circuit. Therefore, it is possible to compare the time signal of the write strategy with the time signal of the laser emission.

Further, according to claim 17 of the present invention, the optical disc recording apparatus defined in claim 6 or 7 further includes a duty correction circuit for correcting the setting of the duty rate of the multipulse on the basis of the ideal value and the measured value, and the laser power control circuit performs a peak power conversion calculation on the basis of the output of the voltage measurement circuit and the corrected duty ratio. Therefore, it is possible to perform power correction for multipulse laser control.

Further, according to claim 18 of the present invention, the optical disc recording apparatus defined in claim 1 or 10 further includes a nonvolatile memory for holding values of correction parameters that are calculated by the phase setting replacement circuit. Therefore, it is possible to reduce the time required for start-up of the recording apparatus by using the stored corrected values which have previously been obtained in the process adjustment.

### BRIEF DESCRIPTION OF THE DRAWINGS

FIG. 1 is a block diagram of an optical disc recording apparatus according to a first embodiment of the present invention.

FIG. 2 is a signal waveform diagram in the case where the duty ratio becomes 50% with the multipulse phase setting Tmp=0.5T in the optical disc recording apparatus according to the first embodiment.

FIG. 3 is a signal waveform diagram in the case where the duty ratio becomes 0% with the multipulse phase setting Tmp=0 in the optical disc recording apparatus according to the first embodiment.

FIG. 4 is a signal waveform diagram in the case where the duty ratio becomes 100% with the multipulse phase setting Tmp=1T in the optical disc recording apparatus according to the first embodiment.

FIG. 5 is a diagram illustrating the relationship between the 1T multipulse width setting and the measured level.

FIG. 6 is a flowchart illustrating the procedure for correcting the phase setting in the optical disc recording apparatus according to the first embodiment.

FIG. 7 is a flowchart illustrating the measurement procedure for obtaining an AD-converted value for each phase setting in the optical disc recording apparatus according to the first embodiment.

FIG. 8 is a diagram illustrating examples of measured values obtained in the optical disc recording apparatus according to the first embodiment.

FIG. 9 is a diagram illustrating a formula for calculating an ideal value in the optical disc recording apparatus according to the first embodiment.

FIG. 10 is a diagram illustrating examples of measured values and calculated ideal values obtained in the optical disc recording apparatus according to the first embodiment.

FIG. 11 is a flowchart illustrating the procedure of searching an optimum phase setting, and correcting the phase setting.

FIG. 12 is a diagram illustrating examples of correction results obtained in the optical disc recording apparatus according to the first embodiment.

FIG. 13 is a graph illustrating the examples of the correction results obtained in the optical disc recording apparatus according to the first embodiment.

FIG. 14 is a signal waveform diagram in the case where the duty ratio becomes 50% with the multipulse phase setting Tmp=0.5T when the multipulse is 2T in an optical disc recording apparatus according to a second embodiment of the present invention.

FIG. 15 is a signal waveform diagram in the case where the duty ratio becomes 50% with the multipulse phase setting Tmp=1.0T in the optical disc recording apparatus according to the second embodiment of the present invention.

FIG. 16 is a signal waveform diagram in the case where the duty ratio becomes 75% with the multipulse phase setting Tmp=1.5T in the optical disc recording apparatus according to the second embodiment of the present invention.

FIG. 17 is a diagram illustrating the relationship between the width setting for the 2T multipulse and the measured level.

FIG. 18 is a waveform diagram in the case where a block pulse having a length of 1T is outputted in a 3T mark in the optical disc recording apparatus according to a third embodiment of the present invention.

FIG. 19 is a waveform diagram in the case where a block pulse having a length of 1.5T is outputted in a 3T mark in the optical disc recording apparatus according to the third embodiment.

FIG. 20 is a waveform diagram in the case where a block pulse having a length of 2T is outputted in a 3T mark in the optical disc recording apparatus according to the third embodiment.

FIG. 21 is a diagram illustrating the relationship between the width setting for the top pulse and the measured level in the optical disc recording apparatus according to the third embodiment.

FIG. 22 is a block diagram illustrating an optical disc recording apparatus according to a fourth embodiment of the present invention.

FIG. 23 is a diagram illustrating examples of measurement results of measured values [n] and standard device [n] in the optical disc recording apparatus according to the fourth embodiment.

FIG. 24 is a diagram illustrating an example of measurement result obtained in the optical disc recording apparatus according to the fourth embodiment.

FIG. 25 is a block diagram illustrating an optical disc recording apparatus according to a fifth embodiment of the present invention.

FIG. 26 is a waveform diagram in the case where the duty ratio becomes 50% with the multipulse phase setting Tmp=0.5T in the optical disc recording apparatus according to the fifth embodiment.

FIG. 27 is a flowchart illustrating the measurement procedure performed by the optical disc recording apparatus according to the fifth embodiment.

FIG. 28 is a block diagram illustrating a pickup in an optical disc recording apparatus according to a sixth embodiment of the present invention.

FIG. 29 is a block diagram illustrating an optical disc recording apparatus according to a seventh embodiment of the present invention.

FIG. 30 is a block diagram illustrating an optical disc recording apparatus according to an eighth embodiment of the present invention.

FIG. 31 is a diagram illustrating a calculation formula for calculating a corrected value of a duty ratio in the optical disc recording apparatus according to the eighth embodiment.

FIG. 32 is a diagram illustrating the result obtained by correcting the duty ratio in the optical disc recording apparatus according to the eighth embodiment.

### DESCRIPTION OF REFERENCE NUMERALS

1 . . . optical disc
2 . . . pickup
3 . . . laser control system
3a . . . mark detection system
4 . . . phase detection/setting system
5 . . . recording data generation system
6 . . . laser diode (LD) driver
7 . . . laser (LD)
8 . . . photodetector
9 . . . attenuator (ATT) circuit
10 . . . low-pass filter (LPF) circuit
11 . . . sample/hold (SH) circuit
12 . . . selector switch
13 . . . voltage gain amplifier (VGA)
14 . . . AD conversion circuit
15 . . . voltage gain amplifier (VGA)
16 . . . sample/hold (SH) circuit
17 . . . voltage gain amplifier (VGA)
18 . . . AD conversion circuit
19 . . . laser APC (Auto Power Control) circuit
20 . . . DAC
21 . . . recording data storage circuit
22 . . . recording modulation circuit
23 . . . write strategy generator circuit
24 . . . phase setting circuit
25 . . . multilayer clock generation circuit
26 . . . low-pass filter (LPF) circuit
27 . . . sample/hold (SH) circuit
28 . . . voltage gain amplifier (VGA) circuit
29 . . . AD conversion circuit
30 . . . CPU
31 . . . RAM
32 . . . phase setting table
33 . . . duty correction circuit
34 . . . signal conversion circuit
35 . . . signal selector switch
36 . . . signal selector switch
37 . . . standard signal generation device
38 . . . SH position setting circuit
39 . . . ON switch
40 . . . lens
41 . . . actuator
42 . . . focus drive circuit

### BEST MODE TO EXECUTE THE INVENTION

### Embodiment 1

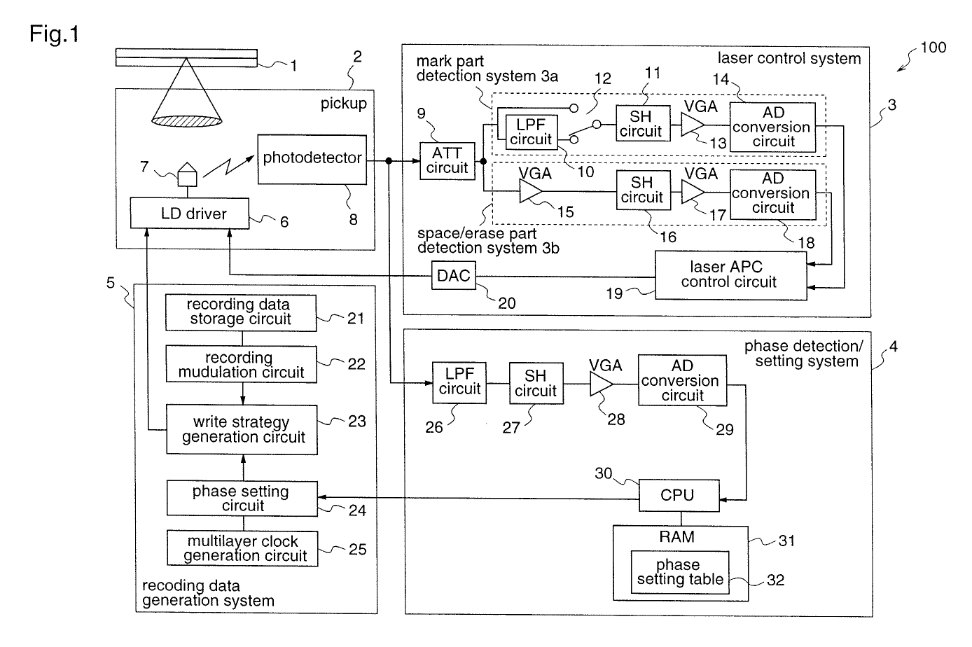

FIG. 1 is a block diagram illustrating the construction of an optical disc recording apparatus according to a first embodiment of the present invention.

With reference to FIG. 1, the optical disc recording apparatus according to the first embodiment includes a pickup 2 for emitting a laser to an optical disc 1 to perform writing and reading of information to/from the optical disc 1, a laser control system 3 for controlling the laser output power, a phase detection/setting system 4 for controlling phase detection and phase setting of a write strategy, and a recording data generation system 5 for generating recording data.

In the pickup 2, a laser diode (LD) 7 is current-driven by a laser diode (LD) driver 6, and laser light is emitted from the LD 7 to the optical disc 1. Reflected light of the laser light is received by a photodetector 8 as a light-receiving element, and the intensity of the light received by the photodetector 8 is converted into a voltage level. The light converted into the voltage level is output to the subsequent laser control system 3 and phase detection/setting system 4.

The laser control system 3 includes an attenuator (ATT circuit) 9, a mark part detection system 3a, a space/erase part detection system 3b, a laser APC (Auto Power Control) circuit 19, and a DAC 20.

When the voltage level outputted from the photodetector 8 is high, the ATT circuit 9 reduces the voltage level. In recent years, the recording speed of the optical disc recording apparatus has been increased, and the ATT circuit 9 reduces the voltage level when the LD 7 emits light with a high power. An output signal from the ATT circuit 9 is supplied to the mark part detection system 3a and to the space/erase part detection system 3b.

The mark part detection system 3a samples and holds the laser power level (voltage level) when the laser is emitted to a mark part, and measures the level. The mark part detection system 3a comprises a frequency-adjustable low-pass filter (LPF circuit) 10, a selector switch 12, a sample/hold circuit (SH circuit) 11, a voltage gain amplifier (VGA) 13, and an AD conversion circuit 14. When the output signal from the ATT circuit 9 has a multipulse waveform, the mark part detection system 3a makes the signal pass through the LPF 10 to average the signal level, and samples and holds the averaged power level of the multipulse with the SH circuit 11, and measures the level. The SH circuit 11 samples and holds the voltage level corresponding to the laser power level on the basis of a sample/hold (SH) signal for mark (not shown). Thereafter, the output of the SH circuit 11 is gain-controlled by the VGA 13 in accordance with the recording speed and the laser power during recording, and then it is AD-converted by the AD conversion circuit 14.

The space/erase part detection system 3b samples and holds the laser power level (voltage level) when the laser is emitted to a space part/erase part, and measures the level. The space/erase part detection system 3b comprises a voltage gain amplifier (VGA) 15, a sample/hold circuit (SH circuit) 16, a voltage gain amplifier (VGA) 17, and an AD conversion circuit 18. Since the laser power to the space part is lower than those to the erase part and the mark part, the signal of the laser power level (voltage level) to the space part is increased in its gain by the VGA 15. On the other hand, since the laser power to the erase part is sufficiently large, it is not necessary to increase the gain thereof. The output signal (level) from the VGA 15 is sampled and held by the SH circuit 16 on the basis of a SH signal for space (not shown). The sampling/holding of the laser power level for the erase part is identical to that for the space part. Thereafter, the output of the SH circuit 16 is subjected to signal gain adjustment by the VGA 17 in accordance with the recording speed and the laser power during recording, and then the signal is AD-converted by the AD conversion circuit 18.

The laser APC (Auto Power Control) circuit 19 receives the AD-converted values detected by the mark part detection system 3a and the space/erase part detection system 3b, and calculates the drive current for the LD 7 on the basis of the AD-converted values to supply the drive current to the LD driver 6. Further, the DAC 20 converts the output of the laser APC control circuit 19 into an analog signal, and outputs the analog signal to the LD driver 6.

Hereinafter, the laser power control method by the above-mentioned laser control system 3 will be described. Since the operation of sampling/holding the laser power level for the erase part is identical to that for the space part, repeated description is not necessary.

Initially, a description will be given of the power control for the LD 7 when reproducing information from the optical disc 1.

In order to constantly control the power of the LD 7 to a reproduction power required for reproducing information from the optical disc 1, the laser APC control circuit 19 sets an initial current value on the LD driver 6, and the LD driver 6 makes the LD 7 emit light on the basis of the current value. Thereafter, the output signal from the photodetector 8 is transmitted through the ATT circuit 9, and AD-converted by the space/erase part detection system 3b. Then, the laser APC control circuit 19 controls the value of the drive current so that the AD-converted value reaches a target laser power. During reproduction, the laser APC control circuit 19 controls the laser power to a predetermined target value.

Next, a description will be given of the power control for the LD 7 when recording information to the optical disc 1.

Usually, a recording waveform NRZI is constituted by waveforms of mark parts and waveforms of space parts which are alternately outputted. When forming one recording mark, a write strategy is generated from the recording waveform NRZI in accordance with the material and characteristics of the media or the recording speed, and laser is emitted according to the write strategy, and therefore, the emitted waveform of the laser takes various shapes. Further, the amount of current required for the LD 7 to emit the target power varies depending on the temperature characteristics. Therefore, in order to control the laser powers of the mark part and the space part to the target powers, the respective laser power levels are measured, and laser APC control is performed to make the laser powers constant.

The mark part detection system 3a samples and holds the laser power level of the mark part which shows a multipulse waveform, and measures the level. When the waveform of the mark part is a multipulse comprising plural pulses, the mark part detection system 3a controls the selector switch 12 so that the signal passes through the LPF circuit 10, and averages the signal level by using the LPF circuit 10, and then samples and holds the averaged level to measure the level. Assuming that the ratio between time Tp in which a high power for recording appears and time Tb in which a bottom power as a low power for reproduction appears, i.e., Tp/(Tp+Tb), is the duty ratio, when calculating a target power from the multipulse waveform, conversion of a peak power is performed according to the obtained averaged level and the duty ratio. For example, assuming that the duty ratio is 50% and the obtained averaged level is ave, the actually emitted peak power is calculated as ave/50%=ave×2 by the laser APC control circuit 19. The averaged power level thus detected is sampled and held by the SH circuit 11. Then, the value of the drive current is controlled by the laser APC control circuit 19 so that the AD-converted value reaches the target laser power.

When the output from the ATT circuit 9 is a non-multipulse waveform, the mark part detection system 3a controls the selector switch 12 so that the signal from the ATT circuit 9 bypasses the LPF circuit 10, and measures the level. In this case, since measurement of the level can be directly performed, it is not necessary to calculate the duty ratio. Further, even in the case where the output from the ATT circuit 9 is a multipulse, the mark part detection system 3a may control the selector switch 12 so that the output signal from the ATT circuit 9 bypasses the LPF circuit 10 to sample and hold a top pulse portion. Also in this case, since measurement of the level can be directly performed, calculation it is not necessary to calculate the duty ratio.

On the other hand, in the space/erase part detection system 3b, the laser power level of the space part is sampled and held and thereby the level is measured by the similar method as that previously described for reproduction. Then, the value of the drive current is controlled by the laser APC control circuit 19 so that the AD-converted value reaches the target laser power.

Next, with reference to FIG. 1, the phase detection/setting system 4 controls phase detection for the write strategy, determination of the phase, and the like. The phase detection/setting system 4 comprises a frequency-adjustable low-pass filter (LPF circuit) 26, a sample/hold circuit (SH circuit) 27, a voltage gain amplifier (VGA) 28, a CPU 30, and a RAM 31. A nonvolatile memory may be provided instead of the RAM 31, and the various kinds of data to be stored in the RAM 31 may be stored in the nonvolatile memory.

In the phase detection/setting system 4, the light signal converted into the voltage level by the photodetector 8 is subjected to electric processing as follows, and setting of a time axis of the write strategy is detected as a voltage level.

That is, the multipulse waveform of the mark part which is converted into the voltage level is transmitted through the LPF 26, whereby the average power level of the multipulse is detected. The detected average power level is sampled and held by the SH circuit 27. Thereafter, the signal is subjected to gain control by the VGA 28 according to the recording speed or the laser power during recording, and then AD-converted by the AD conversion circuit 29.

The CPU 30 successively changes the phase setting of the write strategy, and obtains a measured value outputted from the AD conversion circuit 29 for each phase setting. Then, the CPU 30 performs linear approximation on the basis of the measured value to obtain an ideal value of the measured value for each phase setting, and obtains, as an optimum phase setting, a phase setting with which a difference between the measured value and the ideal value is minimized, and then stores the optimum phase setting in a phase setting table 32 in the RAM 31. The specific operation of the phase detection/setting system 4 will be described later.

The recording data generation system 5 generates recording data to be recorded in the optical disc 1. The recording data generation system 5 comprises a recording data storage circuit 21, a recording modulation circuit 22, a write strategy generator circuit 23, a phase setting circuit 24, and a multiphase clock generation circuit 25.

In the recording data generation system 5, recording data stored in the recording data storage circuit 21 is modulated according to a predetermined standard by the recording modulation circuit 22. Then, a recording waveform NRZI signal is supplied from the recording modulation circuit 22 to the write strategy generator circuit 23.

The phase setting circuit 24 selects a reference clock generated by the multiphase clock generation circuit 25 on the basis of the value stored in the phase setting table 32 which is read by the CPU 30, and inputs the reference clock to the write strategy generator circuit 23.

The write strategy generator circuit 23 generates a write strategy that is optimum for recording into the optical disc 1, on the basis of the outputs from the recording modulation circuit 22 and the phase setting circuit 24, in accordance with the characteristics of the optical disc 1, the recording speed, and the like. At this time, in order to generate plural pulses or a single pulse which are/is shorter than a repetition period 1T for recording to be a reference, the write strategy generator circuit 23 determines the phase of the write strategy with reference to a multiphase clock having a higher resolution than 1T. Then, the LD driver 6 makes the LD 7 emit light on the basis of the write strategy. The phase setting table 32 stored in the RAM 31 in the phase detection/setting system 4 may be stored in the phase setting circuit 24 or the like.

Next, a description will be given of the relationship between the phase setting for the multipulse and the measured value of the averaged level of the multipulse obtained in the phase detection system 4.

As described above, the laser power level of the mark part showing the multipulse waveform is averaged by the LPF circuit 27, and the averaged level is sampled and held and thereby the level is measured. At this time, since the laser APC control is performed to make the laser power constant, when the phase setting Tmp of the multipulse changes, the level averaged by the LPF circuit 27 changes.

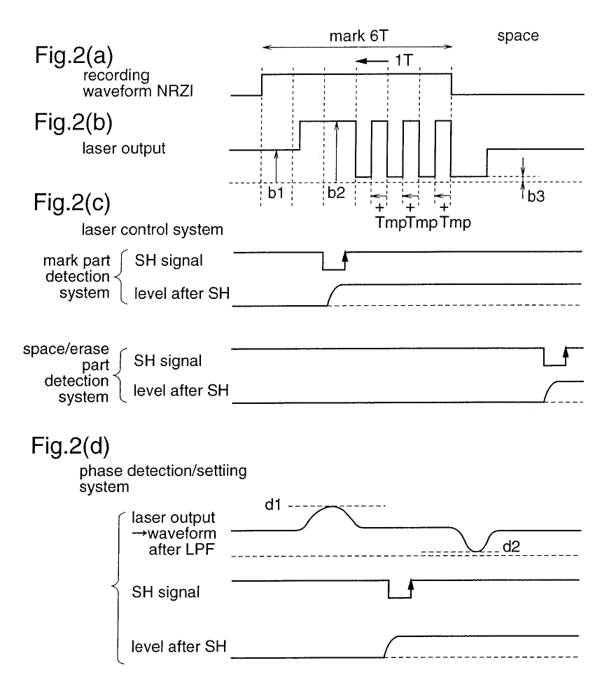

Hereinafter, a description will be given of the case where the output period of the multipulse is set to 1T which is a fundamental period of a mark/space length (1T multipulse), with reference to FIG. 2.

FIG. 2 shows signals of a mark and a space during recording, in the case where the phase setting of the multipulse of the write strategy is Tmp=0.5T and the duty ratio thereof is 50%. FIG. 2(b) shows the laser output, wherein Tmp indicates the phase setting of the multipulse, and the phase setting is variable in the direction of arrow (+) of Tmp. Further, the start point of the arrow of Tmp is fixed. In FIG. 2, since the fundamental period is 1T, Tmp is variable from 0T to 1T.

FIG. 2(a) shows the recording waveform NRZI as an output signal from the recording modulation circuit 22, and a section of HIGH is a mark part wherein data is recorded and a section of LOW is a space part wherein data is not recorded or is erased. The space part is APC-controlled with a bias power b1, and the multipulse of the mark part is controlled with a peak power b2. Further, as for a bottom power b3, current is set so as to be a laser power during reproduction. This bottom power b3 may be varied according to the recording characteristics.

FIG. 2(c) shows the signal outputs in the laser control system 3a, i.e., it shows the SH signal and the output of the SH circuit in the mark part detection system 3a as well as the SH signal and the output of the SH circuit 16 in the space/erase part detection system 3b. In the laser control system 3a, the SH signal for detecting the level of the mark part is sampled in the LOW section, and the sampling level is held at the timing from LOW to HIGH. Further, in the space/erase part detection system 3b, the SH signal for detecting the level of the space part is sampled in the LOW section, and the sampling level is held at the timing from LOW to HIGH. In the first embodiment of the present invention, if the meanings of sampling and holding are same, the same operation may be performed with inversely setting the polarities of LOW and HIGH of the SH signal.

FIG. 2(d) shows the output of the LPF circuit 26, the SH signal, and the output of the SH circuit 27 in the phase detection/setting system 4, respectively. In the phase detection/setting system 4, since the duty ratio of 50%, the signal to be averaged by the LPF circuit 10 is ideally averaged at the level of 50% that is obtained by subtracting the bottom power d2 from the peak power d1 as shown in FIG. 2(d). At the position of this mark part, sampling is carried out in the section of LOW by the SH signal, and the sampling level is held at the timing from LOW to HIGH.

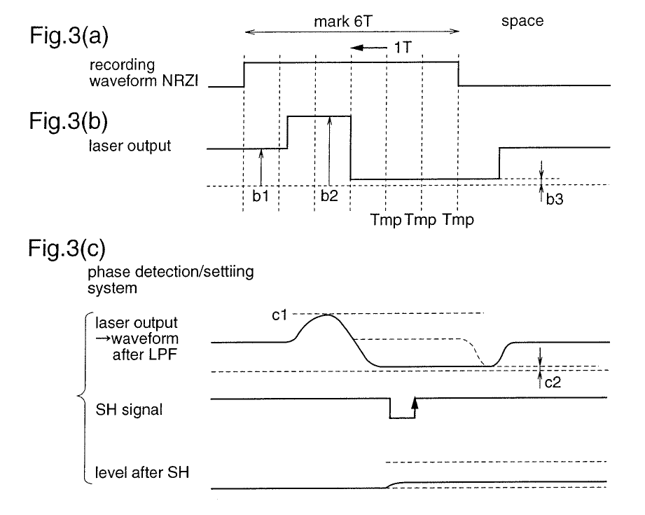

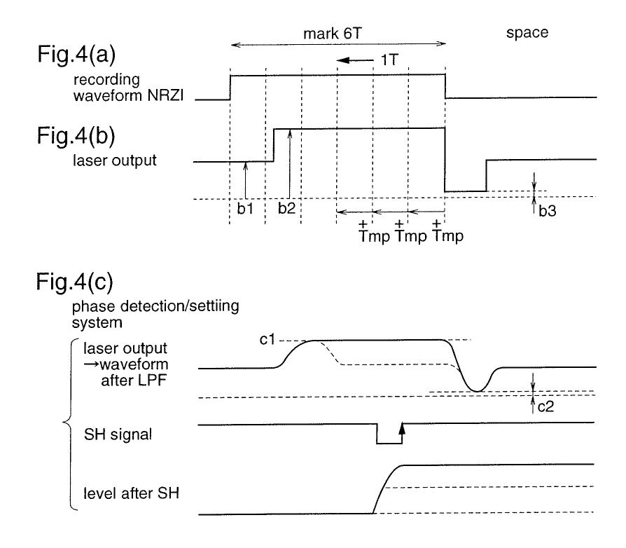

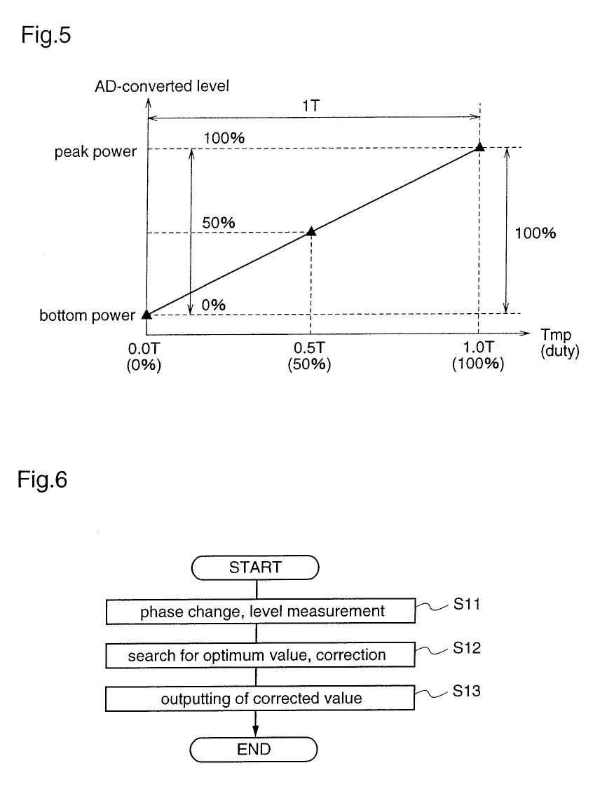

Further, in the phase detection/setting system 4, as shown in FIG. 3, when the phase setting of the multipulse is Tmp=0 and the duty ratio as the recording power emission ratio in 1T unit is 0%, the level averaged by the LPF circuit 10 is detected at approximately the same level as the bottom power c2 as shown in FIG. 3(c). For example, as shown in FIG. 4, when the phase setting of the multipulse is Tmp=1T and the duty ratio as the recording power emission ratio in 1T unit is 100%, the level averaged by the LPF circuit 10 is detected at approximately the same level as the peak power c1 as shown in FIG. 4(c). The results shown in FIGS. 2, 3, and 4 are organized to represent the relationship of the detected levels when the phase setting of the multipulse is varied, resulting in FIG. 5.

FIG. 5 shows a time axis from 0% to 100% of 1T that is the fundamental period of the mark/space length, in relation to the bottom power to the peak power of the averaged level. In FIG. 5, the abscissa shows the multipulse setting Tmp of the write strategy circuit and the duty ratio, and the ordinate shows the AD-converted level of the signal that is held by the SH circuit 27. As shown in FIG. 5, in this first embodiment, the relationship between the width setting of the 1T multipulse and the measured level is represented by a straight line in which the AD-converted level is the level of the bottom power when the duty ratio is 0% while it is the level of the peak power when the duty ratio is 100%.

Next, a description will be given of the operation of sampling the voltage level corresponding to the phase setting of the write strategy to determine an optimum phase value, in the optical disc recording apparatus 100 constituted as described above. Hereinafter, it is assumed that the resolution of 1T which is the fundamental period of the mark/space length is 1/10.

The resolution of 1T being 1/10 means that phase setting for the multipulse can be performed in 0.1T. In the optical disc recording apparatus of the first embodiment, the resolution may be 1/n (n: arbitrary integer). Even when the arbitrary resolution of 1/n is adopted, the same result as in the case where the resolution is 1/10 can be obtained.

FIG. 6 is a flowchart illustrating the outline of the operation of correcting the phase setting of the write strategy to output an optimum phase setting by the optical disc recording apparatus 100 according to the first embodiment.

Initially, in step S11, the phase setting of the write strategy is successively varied to measure the signal levels in the respective phase settings. Next, in step S12, an optimum value is searched for each of the phase settings to obtain an optimum phase setting. In step S13, the optimum phase value is outputted.

Hereinafter, steps S11 and S12 will be described in more detail. Initially, the process of step S11 will be described.

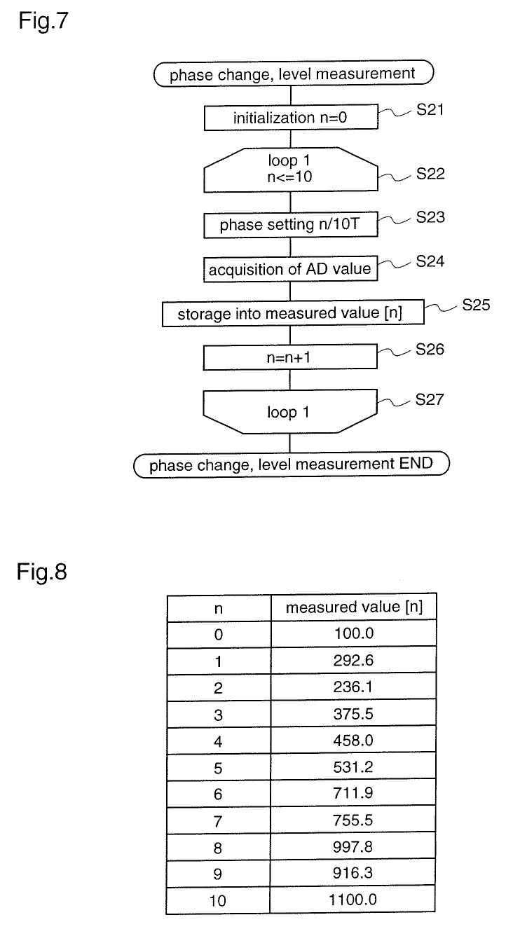

FIG. 7 is a flowchart illustrating the operation of successively setting the phase of the multipulse with the minimum resolution, and measuring the average level for each of the phase settings. The respective steps described below are executed by the CPU 30, and variables and array variables used in this flow are stored in the RAM 31 that is connected to the CPU 30.

Initially, in step S21, a variable is initialized. This variable is variable n indicating the number of times of measurement, and n is an integer ranging from 0 to 10 in this first embodiment.

Next, a process of loop 1 comprising steps S22 to S27 is formed, and when the variable n is equal to or smaller than 10, steps S23 to S27 are repeatedly performed.

That is, phase_{—}0/10 is set in step S23, an AD value at the phase_{—}0/10 is obtained in step S24, and the obtained AD value is stored in array_measured value[0] in step S25. Next, 0 is incremented in step S26, and it is judged in step S27 whether the loop 1 which is formed under the condition of step S22 should be continued or terminated, and thereafter, the loop 1 is repeated until a measured value[10] is obtained.

According to the above-described measurement, the measurement result as shown in FIG. 8 is obtained.

While in the first embodiment of the invention n is incremented from 0 so that the duty ratio varies from 0% to 100%, n may be decremented from 10 so that the duty ratio varies from 100% to 0% with the same measurement result. Further, before or after the execution of step S23 or step S24, a wait time may be set for stability after setting or stability of measurement.

Next, the process of step S12 will be described.

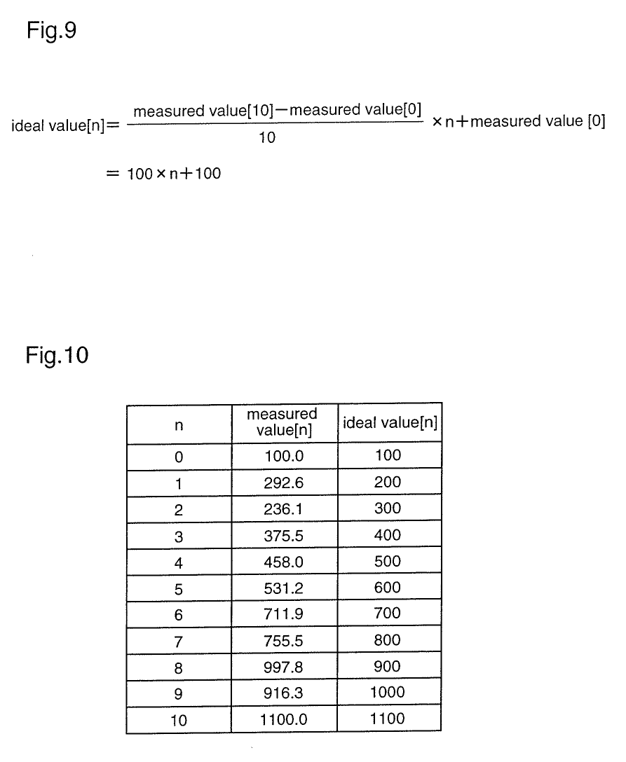

Initially, before an optimum value of phase setting is searched, an ideal value for correcting the phase setting of the write strategy is calculated. The ideal value is calculated from the measurement result obtained in step S11, and it is obtained by performing linear approximation from the array variable_measured value[0] which holds the measurement result with the duty ratio being 0% and the array variable_measured value[10] which holds the measurement result with the duty ratio being 100%. A linear approximation formula is shown in FIG. 9, and an ideal value is obtained as follows by linear approximation from the measurement result of the first embodiment.

ideal value=100×n+100

FIG. 10 shows the measured values obtained in step S11 and the ideal values obtained by the linear approximation formula.

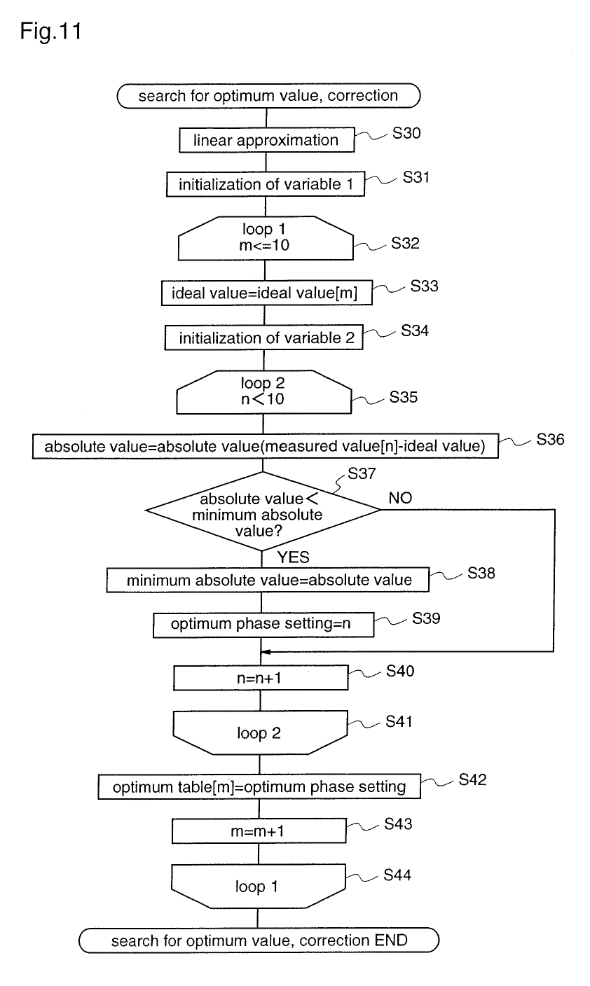

FIG. 11 is a flowchart showing the operation of searching an optimum value of each phase setting from the results of FIG. 10 to correct the phase setting. The optimum value searching process includes searching a measured value closest to an ideal value at a phase setting, and determining a phase setting corresponding to the searched measured value as an optimum phase setting. The measured value closest to the ideal value is calculated from the measurement result and an absolute value of the ideal value. This flow will be described in more detail.

Initially, in step S30, an ideal value for each phase setting value is calculated based on the linear approximation formula shown in FIG. 9, and stored in the array variable_ideal value[n]. In this first embodiment, eleven pieces of data from ideal value [0] to ideal value [10] are stored in the array variable_ideal value[n].

Next, initialization of variable m is performed in step S31. The variable m is a variable to be used for counting of loop 1 which will be described later.

Next, a process of loop 1 comprising steps S32 to S44 is formed, and steps S33 to S43 are repeated when the variable m is less than 10. The process of loop 1 includes searching an optimum value closest to an ideal value with respect to a certain phase setting n from the actually measured result, and determining a phase setting corresponding to the optimum value as an optimum phase setting for the certain phase setting value n.

Next, in step S33, the ideal value which is calculated in step S30 with respect to the phase setting value for which an optimum phase setting is searched is stored in the variable_ideal value[m].

Next, in step S34, initialization of variables is performed. The variables to be initialized in step S34 are variable_n, minimum absolute value, and optimum table[m] which are used for counting of loop 2 which will be described later. The variable_minimum absolute value is a variable which holds a value having a smallest difference from the ideal value when searching a measured value closest to the ideal value in the process of loop 2. As an initial value of the minimum absolute value, a possible maximum value is stored. Further, the variable_optimum table[m] is a variable which holds a phase setting value obtained when a value having a smallest difference from a certain phase setting is searched in the process of loop 1.

Next, a process of loop 2 comprising steps S35 to S41 is formed, and steps S36 to S40 are repeated when the variable n is less than 10. The process of loop 2, which is included in the process of loop 1, includes comparing the ideal value[m] with all the actually measured values with respect to the phase setting values for which an optimum phase setting value is searched, thereby to search a measured value closest to the ideal value.

That is, in step S36, an absolute value of a difference between the array variable_measured value[n] and the calculated ideal value[m] is calculated. In step S37, this difference absolute value and the minimum absolute value are compared, and the process goes to step S38 if the difference absolute value is smaller than the minimum absolute value, while the process goes to step S40 if the difference absolute value is larger than the minimum absolute value.

The difference absolute value is stored in the variable_minimum absolute value in step S38, and the variable n is set in the variable_optimum phase setting in step S39. Then, the variable n is incremented in step S40, and it is judged in step S41 as to whether the loop 2 which is formed under the condition of step S35 should be continued or terminated. When the loop 2 is terminated, the optimum phase setting is stored in the array variable_optimum table[m] in step S42.

Next, the variable m is incremented in step S43, and it is judged in step S44 as to whether the loop 1 which is formed under the condition of step S32 should be continued or terminated. When the loop 1 is terminated, the process of searching the optimum values of the respective phase settings is completed.

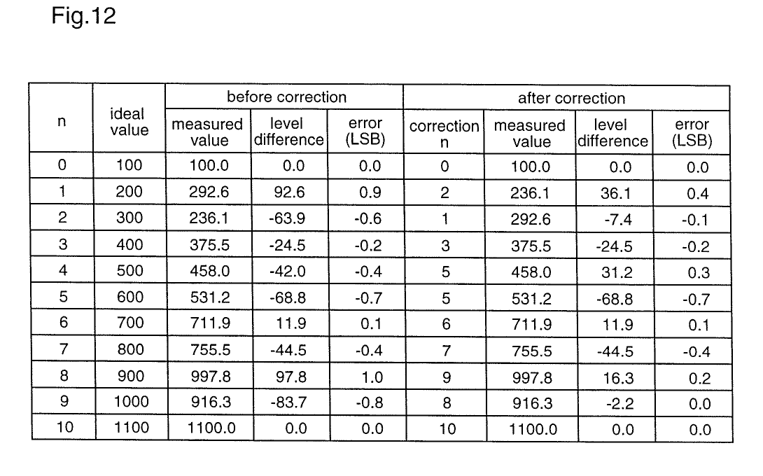

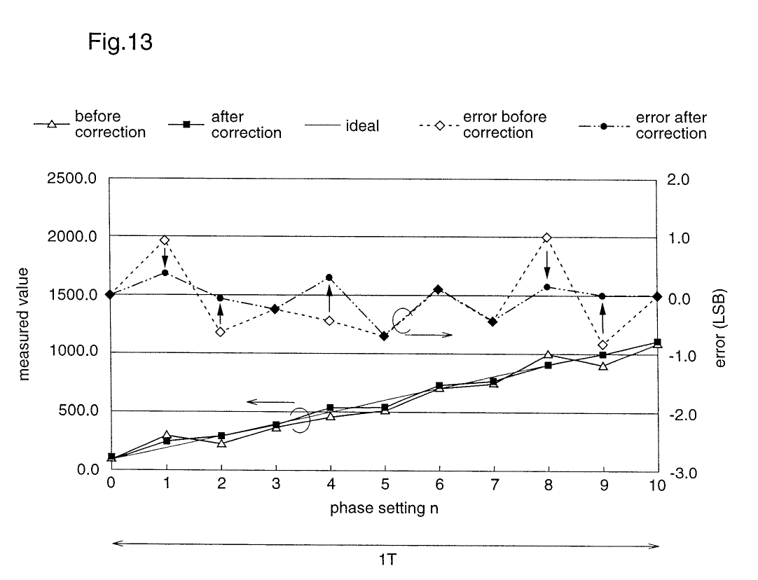

The results of the above-described processes are shown in FIGS. 12 and 13.

FIG. 12 shows the ideal values, measured values, level differences, and errors (LSB) for the phase settings n before and after correction, respectively. In FIG. 12, the ideal values are obtained in step S30, and the measured values are obtained in step S11. The level differences are differences between the measured values and the ideal values, and the errors (LSB) are the results obtained by dividing the differences between the measured values and the ideal values with the inclination of the ideal line, which indicate the errors from the phase settings. In FIG. 12, the column of “correction n” after correction corresponds to the optimum table [m] obtained in the flowchart shown in FIG. 11.

As shown in FIG. 12, the level differences and the errors (LSB) after the correction are smaller than those before the correction.

FIG. 13 is a graph in which the respective numerical values shown in FIG. 12 are plotted, wherein the abscissa shows the phase settings n, and the left-side first axis indicates the measured values while the right-side second axis indicates the errors (LSB). As shown in FIG. 13, with relative to the ideal straight line before the correction, while there are errors of −0.8(LSB) to +1.0(LSB) before the correction, reduced errors of −0.7(LSB) to +0.4(LSB) are obtained after the correction.

The phase settings after the correction, which are obtained by the above-described operation, are stored in the phase setting table 32 in the nonvolatile memory 31. To be specific, the settings which have been stored in order of [0, 1, 2, 3, 4, 5, 6, 7, 8, 9] before the correction are rewritten into [0, 2, 1, 3, 5, 5, 6, 7, 9, 8] according to the correction result.

In the actual output of the write strategy, when there are phase settings n from 0 to 10 as in this first embodiment, correction n=2 is selected when performing setting of n=1. Further, when the phase setting n=4, correction n=5 should be selected. In this way, the CPU 30 sets a phase setting n after correction with respect to a certain phase setting to perform rearrangement of the predetermined phase setting order, thereby enabling optimum phase setting of the write strategy according to the circuit characteristics.

In this first embodiment, the S/N ratio may be improved by varying the setting of the VGA 28 in accordance with the resolution or range of the AD conversion circuit 29.

Alternatively, the S/N ratio may be improved according to the dynamic range of the mark part detection system 3a by varying the laser power. Further, more accurate detection may be performed by comparing the results of varying the setting of the VGA 28 or the laser power, respectively.

Furthermore, while in this first embodiment, as for the case where the resolution of 1T which is the fundamental period of the mark/space length is 1/10, the measurement is performed with the duty ratio of the multipulse being varied from 0% to 100% by varying the phase setting from n=0 to n=10 one by one, the value n to be measured may be arbitrarily set. Further, an arbitrary phase setting can be corrected so long as the measurement results at 0% and 100% in the reference straight line for correction are obtained.

Furthermore, while in this first embodiment, as for the case where the resolution of 1T which is the fundamental period of the mark/space length is 1/10, the measurement is performed with the duty ratio of the multipulse being varied from 0% to 100% by varying the phase setting from n=0 to n=10 one by one, the setting of n=1 or n=9 to be measured is a time width having the shortest width of the output waveform. As the recording speed increases with recent speed-up, the time width becomes shorter. When the time of the rising characteristics and falling characteristics of the signal output exceeds the set time width of the write strategy, a normal waveform is not outputted. Relating to this condition, the rising characteristics and the falling characteristics have previously been defined as product specifications and clarified. When the setting of the recording speed is performed such that no normal waveform is outputted as described above, measurement cannot be performed. Accordingly, when the timing setting is performed such that measurement cannot be performed, measurement is not performed and correction is also not performed. To be specific, as the correction result for n=1, the correction n=1 is selected.

Further, in this first embodiment, linear approximation and correction are performed in step S12, the correction n as the corrected phase setting value is stored in the RAM 31, and the correction n is set for the next write strategy. However, an ideal value as the result of the linear approximation may be stored in the RAM 31. In this case, only the result of the linear approximation is read out, and compared with the output result of the phase setting n of the write strategy, thereby to judge the precision thereof.

Further, in this first embodiment, the CPU 30 may compare the ideal value with the measured value to perform error detection when a predetermined value is exceeded. For example, when the measured value is subtracted from the ideal value and the result of this subtraction exceeds a predetermined value, it is judged as an error. When such error is detected, the corresponding recording apparatus is judged as a defective. Further, the apparatus may be tested again after performing replacement of some component, and when the difference between the ideal value and the measured value is smaller than the predetermined value, this recording apparatus may be judged as a non-defective. Furthermore, even when an error is detected, since it is considered that the predetermined value might be exceeded due to an error in measurement, error detection may be performed again after performing an arbitrary number of times of measurement.

As described above, the optical disc recording apparatus according to the present invention is constituted to perform the processes of setting a part of a write strategy waveform to a multipulse comprising pulses of the same configuration being repeated at predetermined intervals, fixing a phase setting of one pulse edge of the multipulse while successively varying a phase setting of the other pulse edge of the multipulse, performing laser power control for controlling the light intensity of a laser light source to optically detect a laser light which emits a multipulse, averaging a mark part by the LPF circuit and sampling/holding the averaged level, measuring, with a voltage, the averaged level corresponding to the time width of the duty ratio of the multipulse, and rearranging the phase setting order of the pulse edge according to the measurement result so as to reduce a phase error of the pulse edges on the time axis which are actually outputted. Therefore, the phase setting for the actually outputted time axis of the write strategy can be measured at the voltage level, and an optical phase setting by which an error is reduced can be determined for the phase setting having a large error.

Further, when the output period of the multipulse is set to 1T which is the fundamental period of the mark/space length, the duty ratio of the multipulse is varied from 0% to 100% to perform measurement of the levels. Therefore, the whole 1T as the fundamental period can be measured with the minimum resolution, and the phase setting with reduced error can be performed by rearranging the phase setting order on the basis of the measurement result.

Further, assuming that the averaged level is (y1) when the duty ratio of the multipulse with the smallest phase setting is (x1) % while the averaged level is (y2) when the duty ratio of the multipulse with the largest phase setting is (x2) %, the ideal values for the respective phase settings are obtained using a straight line having an inclination of (y2−y1)÷(x2−x1) and a contact of y1. Therefore, the linear approximation can be performed with the two points comprising the beginning point of 1T as the fundamental period and the beginning point of next 1T, whereby all the phase settings can be relatively corrected with the minimum resolution of 1T.

Further, in the optical disc recording apparatus according to the first embodiment, the S/N ratio can be improved by setting an optimum range when performing the measurement at the voltage level. Further, the S/N ratio can be improved by performing plural times of laser power control with varying the laser power by the laser APC control circuit 19, and selecting and setting a most accurate laser power.

Further, in the optical disc recording apparatus according to the first embodiment, since the results of the corrected phase settings are rewritten and stored in the RAM 31, it is possible to realize a reduction in time required for start-up of the optical disc recording apparatus by using the stored corrected values which have previously been obtained during the process adjustment.

Further, since correction for phase setting is not performed in the vicinity of set values which are difficult to measure, phase setting completely different from the original setting is avoided, thereby avoiding an abnormal output.

Further, since the ideal values and the corrected values are stored in the RAM 31, it is possible to realize a reduction in time required for start-up of the optical disc recording apparatus by previously obtaining the corrected values in the process adjustment and using the stored corrected values or ideal values.

### Embodiment 2

Hereinafter, an optical disc recording apparatus according to a second embodiment of the present invention will be described.

The optical disc recording apparatus according to the second embodiment is constituted such that the output period of the multipulse is set to 2T which is a fundamental period of a mark/space length, in the optical disc recording apparatus 100 according to the first embodiment.

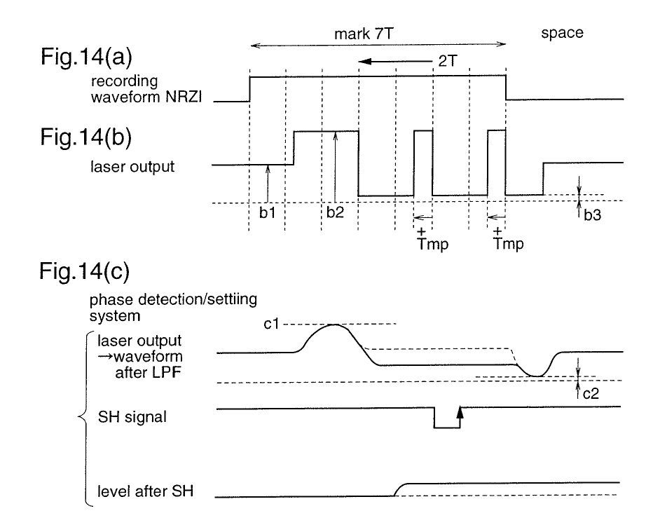

A description will be given of the case where the output period of the multipulse is set to 2T which is the fundamental period of the mark/space length in the optical disc recording apparatus according to the second embodiment, with reference to FIG. 14. The construction and the fundamental operation of the optical disc recording apparatus of this second embodiment are identical to those of the optical disc recording apparatus 100 according to the first embodiment.

In FIG. 14, (a) shows the recording waveform NRZI, (b) shows the laser output, and (c) shows the output of the LPF circuit 26, the output of the SH signal, and the output of the SH circuit 27 in the phase detection/setting system 4. FIG. 14 shows signals of a mark and a space during recording, and it corresponds to the case where the phase setting for the multipulse of the write strategy is Tmp=0.5T and the duty ratio thereof is 25%. The Tmp indicates the phase setting of the multipulse, and the phase setting is variable in the direction of arrow (+) of the Tmp. The start point of the arrow of the Tmp is fixed. Since the fundamental period is 2T, the Tmp is variable from 0T to 2T.

In the 2T as the fundamental period of the mark/space length, a time axis from 25% to 75% is a period corresponding to 1T.

When the phase setting of the multipulse is Tmp=0.5 and the duty ratio as the recording power emission ratio in 2T unit is 25%, the level averaged by the LPF circuit 26 becomes a level equal to 25% of the difference between the peak power and the bottom power as shown in FIG. 14(c), and it is detected by SH circuit 27 as shown in FIG. 14(c).

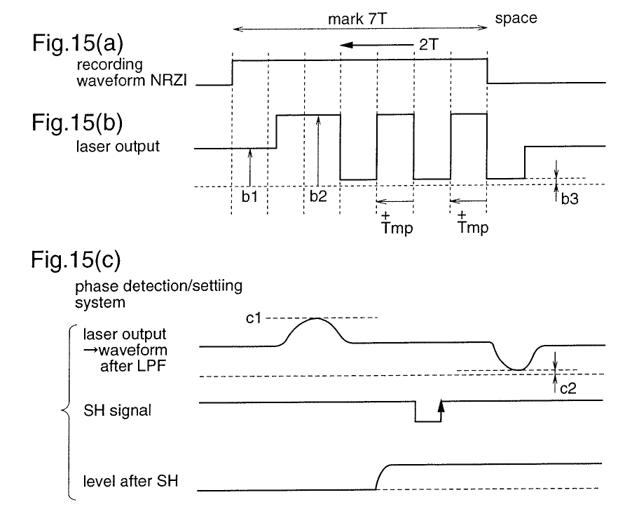

Further, FIG. 15 is a diagram corresponding to the case where the phase setting of the multipulse of the write strategy is Tmp=1.0T and the duty ratio is 50%. When the phase setting of the multipulse is Tmp=1T and the duty ratio as the recording power emission ratio in 2T unit is 50%, the level averaged by the LPF circuit 10 becomes a level equal to 50% of the difference between the peak power and the bottom power as shown in FIG. 15(c), and it is detected by the SH circuit 27 as shown in FIG. 15(c).

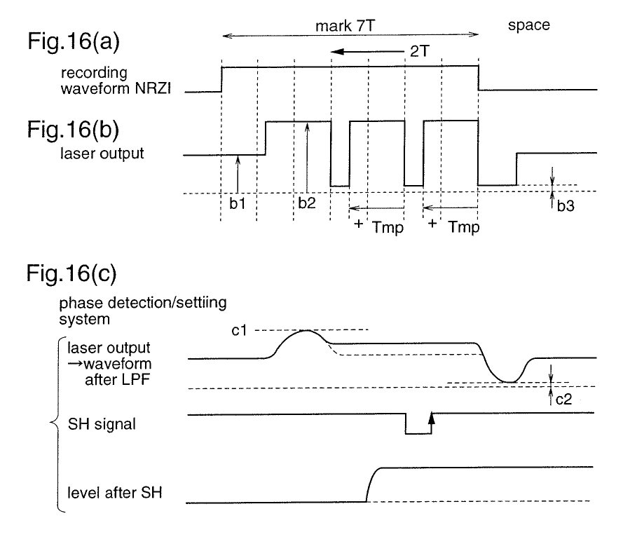

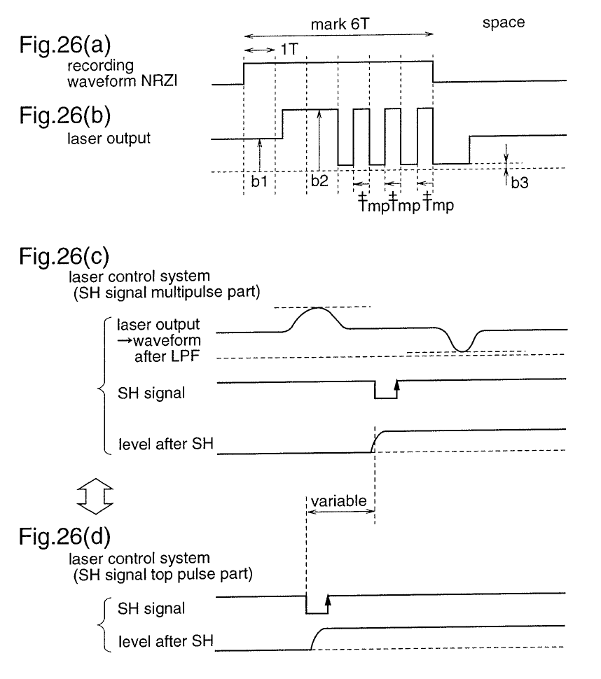

Furthermore, FIG. 16 is a diagram corresponding to the case where the phase setting of the multipulse of the write strategy is Tmp=1.5T and the duty ratio is 75%. When the phase setting of the multipulse is Tmp=1.5T and the duty ratio as the recording power emission ratio in 2T unit is 75%, the level averaged by the LPF circuit 10 becomes a level equal to 75% of the difference between the peak power and the bottom power as shown in FIG. 16(c), and it is detected by the SH circuit 27 as shown in FIG. 26(c).

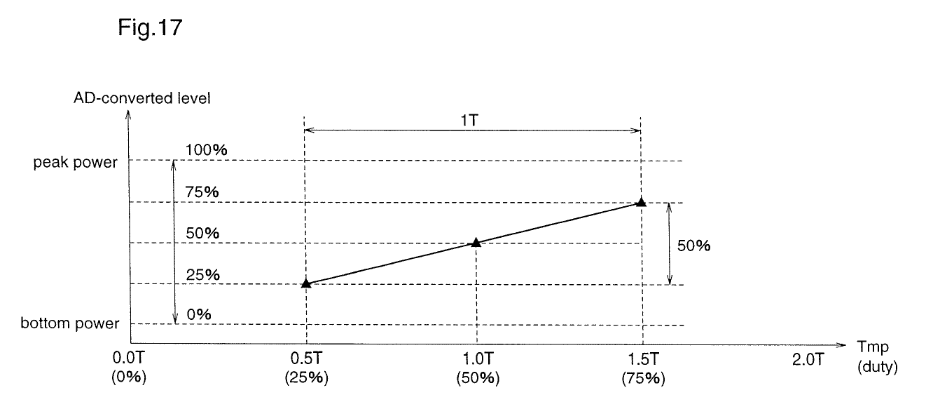

The results shown in FIGS. 14, 15, and 16 are organized to represent the relationship between the phase setting and the measured level obtained when the phase setting of the multipulse is varied, resulting in FIG. 17. In FIG. 17, the abscissa shows the multipulse setting Tmp and the duty ratio of the write strategy circuit, and the ordinate shows the AD-converted level of the level that is held by the SH circuit 27.

As shown in FIG. 17, the relationship between the phase setting and the measured level obtained when the phase setting of the multipulse is varied is represented by a straight line in which the AD-converted level is 25% of the difference between the peak power and the bottom power when the duty ratio is 25% and the AD-converted level is 75% of the difference between the peak power and the bottom power when the duty ratio is 75%. In FIG. 17, the time axis from 25% to 75% in 2T as the fundamental period of the mark/space length is represented in relation to the bottom power to the peak power of the averaged level, and this time width just corresponds to 1T as in the first embodiment.

Accordingly, although in this second embodiment the detectable voltage level is just 50% which is different from that of the first embodiment, if the detection of this voltage level is sufficiently larger than the resolution of the AD conversion circuit 29, it is possible to correct the phase setting of the write strategy with the same method as described for the first embodiment, by obtaining an ideal value for each phase setting using the straight line shown in FIG. 17.

As described above, according to the optical disc recording apparatus of the second embodiment, when the output period of the multipulse is set to 2T which is the fundamental period of the mark/space length, level measurement is carried out with the duty ratio of the multipulse being varied from 25% to 75%. Therefore, the whole 1T as the fundamental period can be measured by the minimum resolution, with the duty ratio ranging from 25% to 75%, and the phase settings can be corrected by rearranging the phase setting order by the same method as adopted in the first embodiment, resulting in reduced errors.

While in this second embodiment the measurement is performed with varying the duty ratio of the multipulse from 25% to 75% by varying the phase setting from n=0 to n=10 one by one in the case where the resolution of 1T which is the fundamental period of the mark/space length is 1/10, an arbitrary setting n can be corrected so long as the measurement results at 25% and 75% in the reference straight line are obtained.

### Embodiment 3

Hereinafter, an optical disc recording apparatus according to a third embodiment of the present invention will be described.

The optical disc recording apparatus according to the third embodiment is constituted such that, when forming one record mark, it is recorded by a write strategy comprising a block pulse constituted by one pulse, in the optical disc recording apparatus 100 according to the first embodiment.

Hereinafter, a description will be given of the operation of the optical disc recording apparatus according to the third embodiment in the case where a 3T mark and a 3T space are outputted with the output of the block pulse being 1T which is a fundamental period of a mark/space length. The construction of the optical disc recording apparatus according to the third embodiment is identical to that of the optical disc recording apparatus 100 according to the first embodiment.

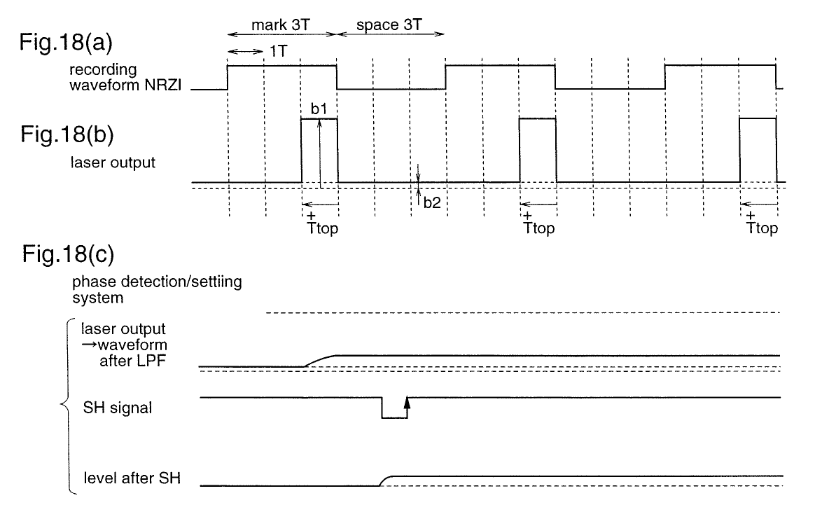

In FIG. 18, (a) shows the recording waveform NRZI, (b) shows the laser output, and (c) shows the output of the LPF circuit 26, output of the SH signal, and output of the SH circuit 27 in the phase detection/setting system 4. FIG. 18 shows signals of marks and spaces during recording, and each block pulse has a length of 1T in the 3T mark. Ttop indicates phase setting for a top pulse which is width setting for this block pulse, and this phase setting is variable in the direction of arrow (+) of the Ttop. Further, a start point of the arrow of the Ttop is fixed. The variable range of the Ttop is not particularly restricted.

Hereinafter, a description will be given of the case where the mark length and the space length are respectively 3T, and the total period of the mark and space lengths is 6T. In the optical disc recording apparatus according to the third embodiment, setting of the cutoff frequency of the LPF circuit 26 is reduced, and the entire laser output corresponding to the mark 3T and the space 3T is averaged. Assuming that the phase setting for performing recording of the mark 3T is Ttop, setting of the Ttop is varied from 1T to 2T, and the entire laser output corresponding to 6T, i.e., the mark 3T and the space 3T, is averaged.

When Ttop=1T, the rate at which a peak power appears in 6T is 1T/6T=16.67%. When Ttop=2T, the rate at which a peak power appears in 6T is 2T/6T=33.33%. That is, the rate at which a peak power appears when Ttop varies from 1T to 2T is 16.67% to 33.33%. When this is represented in relation to the bottom power to the peak power of the averaged level, it becomes a period corresponding to 1T in the time axis. Assuming that the rate at which this peak power appears is identical to the duty ratio, it can be treated similarly as in the first embodiment.

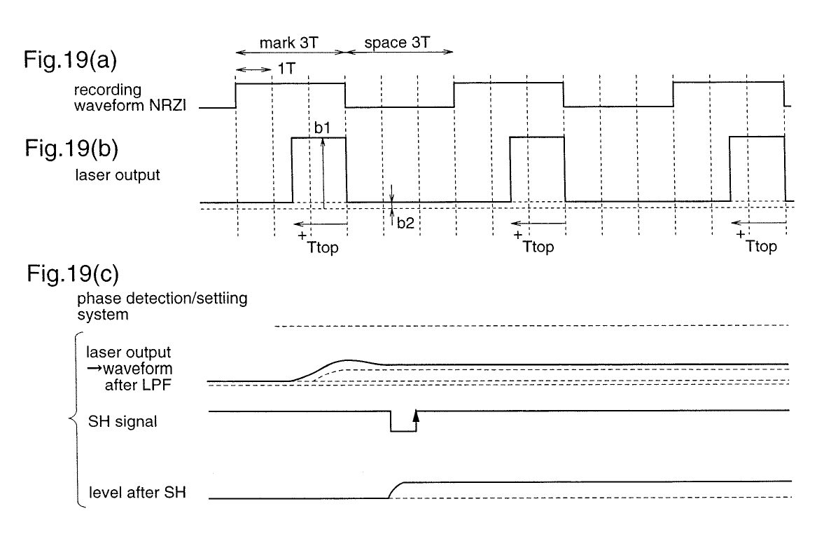

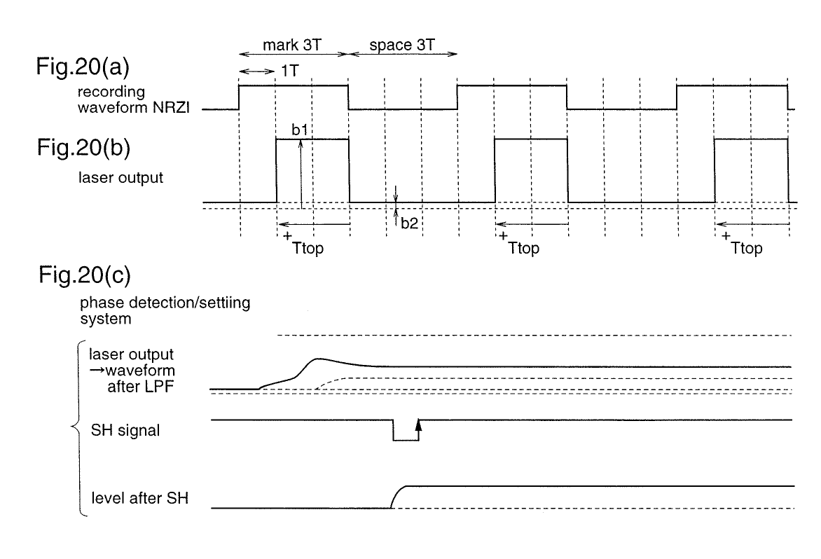

When Ttop=1T and the duty ratio is 16.67%, the level averaged by the LPF circuit 26 is detected as shown in FIG. 18(c). Further, as shown in FIG. 19, when Ttop=1.5T and the duty ratio is 25%, the level averaged by the LPF circuit 26 is detected as shown in FIG. 19(c). Further, as shown in FIG. 20, when Ttop=2T and the duty ratio is 33.33%, the level averaged by the LPF circuit 26 is detected as shown in FIG. 20(c).

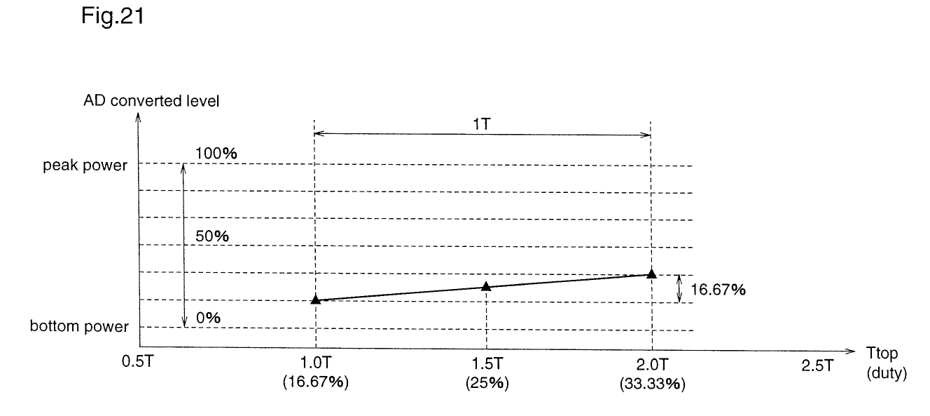

FIG. 21 shows the relationship between the phase setting and the measured level obtained when the phase setting of the top pulse Ttop is varied, with the results shown in FIGS. 18, 19, and 20 being combined. In FIG. 21, the abscissa shows the top pulse setting Ttop and the duty ratio of the write strategy, and the ordinate shows the AD-converted level of the level that is held by the SH circuit 27.

With reference to FIG. 21, a straight line having a level of 16.67% of the difference between the peak power and the bottom power when the duty ratio is 16.67% and having a level of 33.33% of the difference between the peak power and the bottom power when the duty ratio is 33.33% is obtained, and the time axis from 16.67% to 33.33% in 6T as the fundamental period of the mark and space lengths is represented in relation to the bottom power to the peak power of the averaged level. This time width just corresponds to 1T as in the first embodiment.

Accordingly, in this third embodiment, the detectable voltage level is just 16.67%, which is different from that of the first embodiment. However, if the detection of this voltage level is sufficiently larger than the resolution of the AD conversion circuit 29, the phase setting of the write strategy can be corrected by the same method as described for the first embodiment.

As described above, the optical disc recording apparatus according to the third embodiment is constituted such that the output period of the top pulse is set to 6T corresponding to the generation period of mark and space lengths, and the phase setting of the tip pulse is varied by a period corresponding to 1T to perform level measurement. Therefore, the whole 1T as the fundamental period can be measured by the minimum resolution, having the duty ratio ranging from 16.67% to 33.33%, whereby the phase settings can be corrected by rearranging the phase setting order by the same method as adopted in the first embodiment, resulting in reduced errors.

While in this third embodiment the generation period of mark and space lengths is 6T, even when it is set to another period, measurement of the averaged level and correction of the phase setting can be performed similarly as described in the third embodiment with changing the calculation for the duty ratio in accordance with the length of the fundamental period.

### Embodiment 4

Hereinafter, an optical disc recording apparatus according to a fourth embodiment of the present invention will be described.

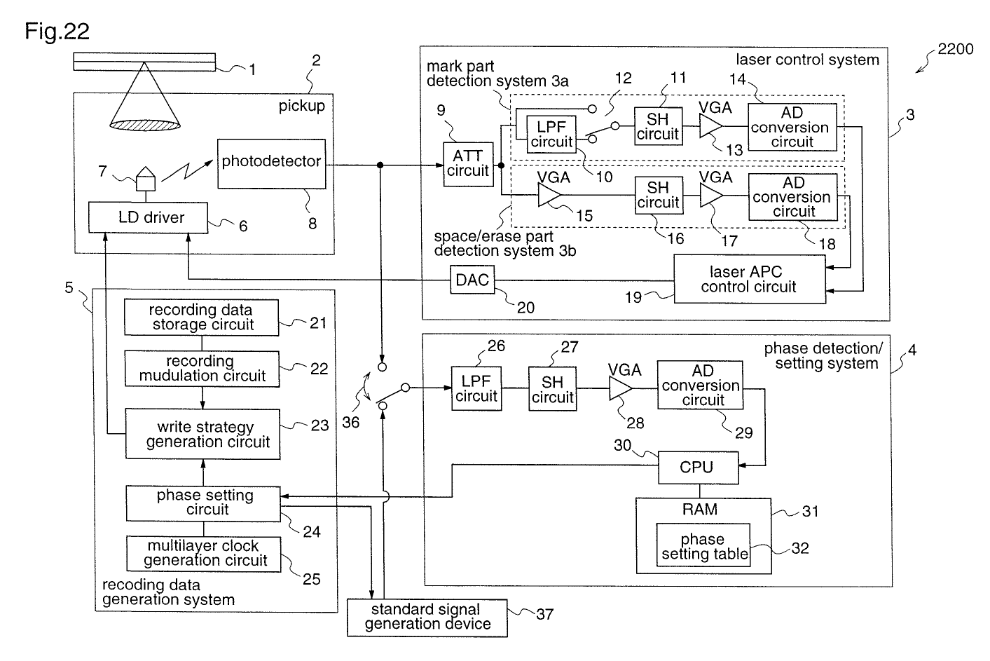

FIG. 22 is a block diagram illustrating the construction of the optical disc recording apparatus 2200 according to the fourth embodiment. With reference to FIG. 22, a signal selector switch 36 switches the input to the LPF 26 between the output of the photodetector 8 and the output of a standard signal generation device 37 which will be described later.

The standard signal generation device 37 receives the output from the phase setting circuit 24, and outputs a waveform signal equivalent to the output of the write strategy circuit 23 for each phase setting, and it is an external device connected to the optical disc device 2200. The output signal from the standard signal generation device 37 has a standard waveform having no variations. In FIG. 22, the same constituents as those shown in FIG. 1 are given the same reference numerals to omit the description thereof.

Next, the operation of the optical disc recording apparatus 2200 according to the fourth embodiment constituted as above will be described.

Initially, the signal selector switch 36 is switched to the standard signal generation device 37 side, and in this state, the phase setting n is successively varied from 0 to 10 each by +1, whereby the output of the standard signal generation device 37 is averaged. The result is stored in variable_standard device[n] in the RAM 32. Next, the signal selector switch 36 is switched to the photodetector 8 side, and the phase setting n is successively varied from 0 to 10 each by +1, whereby the averaged level of the laser power of the multipulse that is converted into the voltage level is detected, and the result is stored in array_measured value[n] in the RAM 32.

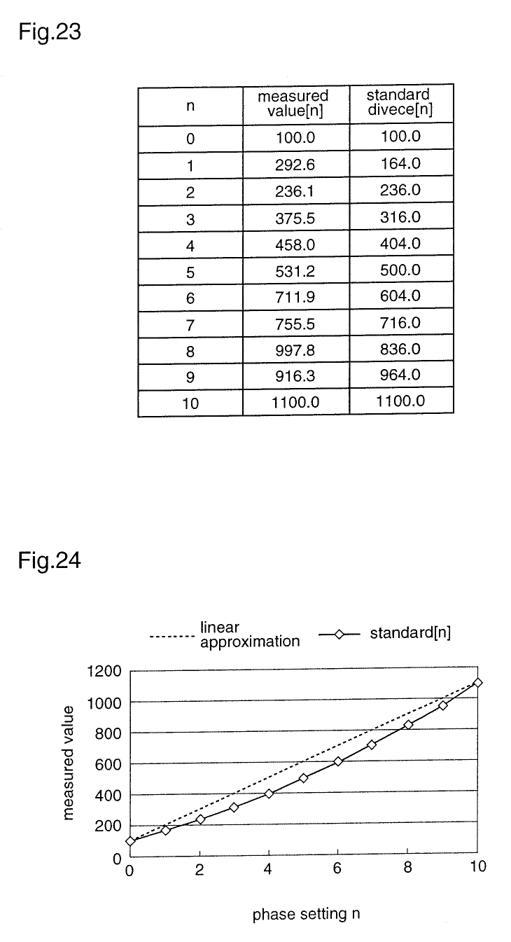

FIG. 23 is a diagram showing the measurement results, and FIG. 24 is a diagram representing the measurement results in a graph. From the measurement result shown in FIGS. 23 and 24, a line that is slightly arched from the ideal straight line can be obtained in the measurement using the standard signal generation device 37 of this fourth embodiment.

In the above-described first embodiment, in step S12, the ideal value is obtained from the linear approximation formula shown in FIG. 9. That is, the ideal value [n] shown in FIG. 10 is a result of obtaining an ideal value from the measurement result and the linear approximation formula obtained from the measurement result. In this fourth embodiment, the ideal value [n] shown in FIG. 10 is replaced with the variable_standard device[n] shown in FIG. 23 to perform the processes in step S12 and the subsequent steps. Thereby, correction of the phase setting can be carried out similarly as in the first embodiment by the phase detection/setting system 4 whose output is corrected by the standard signal generation device 37.

The S/N ratio may be improved by varying the setting of the VGA 28 in accordance with the resolution or range of the AD conversion circuit 29. Further, more accurate detection may be performed by comparing the results of varying the setting of the VGA 28 or the laser power, respectively.

Further, since the standard signal generation device 37 is provided with the purpose of correcting the phase detection/setting system 4, it is assumed as an external device in this fourth embodiment, the standard signal generation device 37 may be provided as a standard signal generator in the phase detection/setting system 4.

As described above, according to the optical disc recording apparatus of the fourth embodiment, the phase detection/setting system is operated so as to average the output of the standard signal generation device 37 which outputs a waveform signal equivalent to that outputted from the write strategy generator circuit, and perform correction for the phase setting using this measured average level as an ideal value. Therefore, correction for the output of the phase detection/setting system 4 can be performed, resulting in more accurate phase setting correction.

### Embodiment 5

Hereinafter, an optical disc recording apparatus according to a fifth embodiment of the present invention will be described.

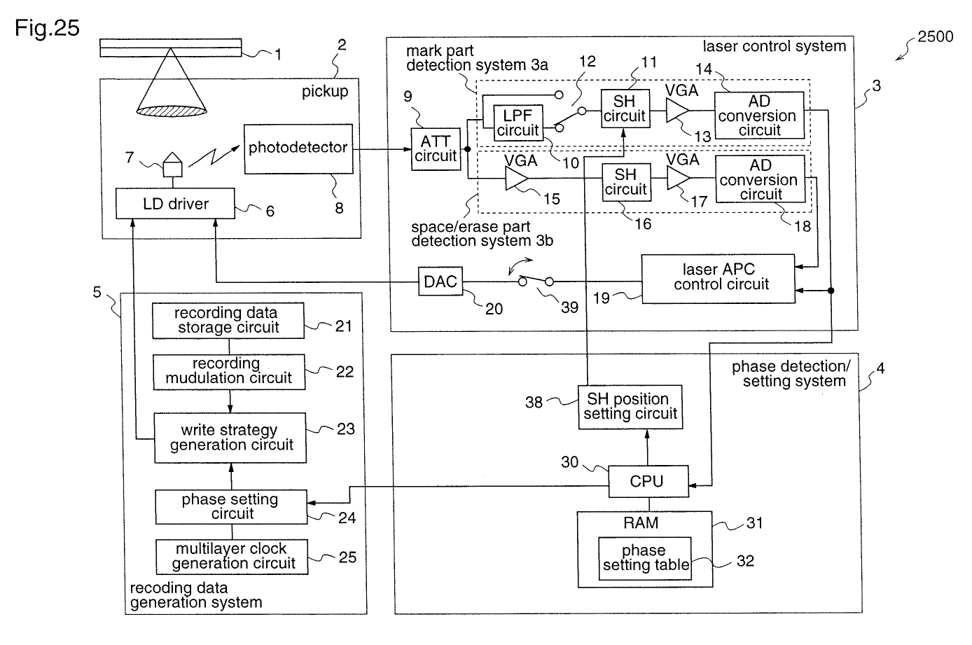

FIG. 25 is a block diagram illustrating the construction of an optical disc recording apparatus 2500 of the fifth embodiment. In FIG. 25, the same constituents as those shown in FIG. 1 are given the same reference numerals to omit the description thereof.

In FIG. 25, 38 denotes a SH position setting circuit for varying the sample/hold position of the SH circuit 11 in the laser control system 3. 39 denotes a switch for controlling ON/OFF of the output of the laser APC control circuit 19. Further, in the optical disc recording apparatus 2500 according to the fifth embodiment, the CPU 30 in the phase detection/setting system 4 receives the output of the AD conversion circuit 14 in the laser control system 3.

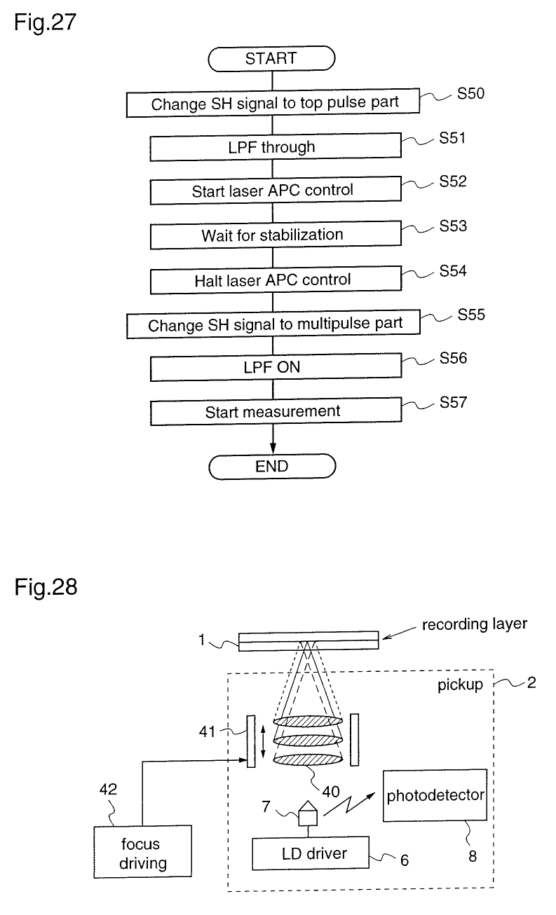

Next, the operation of the optical disc recording apparatus 2500 constituted as described above will be described with reference to FIGS. 26 and 27.

FIG. 26 shows the state where laser output of a 6T mark is performed with a 1T multipulse, wherein (a) shows the recording waveform NRZI, and (b) shows the laser output. Further, FIG. 26(c) shows the output of the LPF circuit 12, the output of the SH signal, and the output of the SH circuit 11 in the case where the SH signal of the SH circuit 11 is positioned at the multipulse part, and FIG. 26(d) the output of the LPF circuit 12, the output of the SH signal, and the output of the SH circuit 11 in the case where the SH signal of the SH circuit 11 is positioned at the top pulse part.

In FIG. 26, the result obtained by AD-converting the signal level after the multipulse part is sampled and held by the SH circuit 11 is smaller than the result obtained by AD-converting the signal level after the top pulse part is sampled and held by the SH circuit 11. Since the level of the LPF circuit 10 of the multipulse part is varied due to the variation in the duty ratio of the multipulse when the phase setting of the multipulse part is varied, laser APC control for constantly outputting the laser cannot be performed using this AD-converted level. Therefore, when performing laser APC control, the sample/hold position is moved to the top pulse part by the SH position setting circuit 38 as shown in FIG. 26(d), and the top pulse part is sampled and held. Then, based on the result obtained by AD-converted the held level with the AD conversion circuit 14, laser APC control is performed by the laser APC control circuit 19.

On the other hand, in the case of detecting the averaged level obtained when the duty ratio of the multipulse waveform is varied by varying the phase setting of the write strategy, as shown in FIG. 26(c), the sample/hold position is moved to the multipulse part by the SH position setting circuit 38, and level measurement is performed. The result obtained by AD-converting the level with the AD conversion circuit 14 is input to the CPU 30 in the phase detection/setting system 4, and correction for the phase setting is carried out based on the detection result by the similar method as described for the first embodiment.

Hereinafter, a description will be given of the operating of measuring the phase of the write strategy with the voltage level by using the laser control system 3 in the optical disc recording apparatus 2500 of the fifth embodiment, with reference to the flowchart shown in FIG. 27.

Initially, in step S50, the SH signal is changed to the top pulse part by the SH position setting circuit 38.

Next, in step S51, the selector switch 12 is switched so that the LPF circuit 10 is bypassed. By bypassing the LPF circuit 10, the emission waveform of the laser that is voltage-converted by the photodetector 8 is input to the SH circuit 11 as it is.

Next, in step S52, laser APC control is carried out, whereby the emission power of the laser is controlled to a predetermined power. At this time, since the top pulse part is sampled and held, the same level is detected even when the duty ratio is varied by varying the phase setting.

Next, after waiting until the laser control is stabilized in step S53, the laser APC control is halted in step S54. This halting of the laser APC control is performed by turning off the switch 39 to make the output of the DAC 20 as the current setting to the LD driver 6 constant. At this time, since the current supplied to the LD driver 6 is constant, the LD 7 emits the laser with the same current.

Next, in step S55, the SH signal is changed to the multipulse part by the SH position setting circuit 38.

Next, in step S56, the selector switch 12 is switched to the LPF circuit 10 side. Then, in step S57, the phase setting of the write strategy is successively varied, and level measurement for each phase setting is carried out. Thereafter, as in the first embodiment, the phase setting order is rearranged based on the measurement values obtained in step S57 and the ideal values, thereby performing correction of the phase setting.

As described above, according to the optical disc recording apparatus of the fifth embodiment, when performing control of the laser power, laser APC control is performed with the sample timing of the SH circuit in the mark detection system being moved to the top pulse part, and when performing correction for the phase setting, the laser control is held to make the amount of current supplied to the laser constant, and level measurement for each phase setting is carried out with the sample timing of the SH circuit in the mark detection system being moved to the multipulse part. Therefore, the time axis for the phase setting of the write strategy can be measured at the voltage level by using the laser power detection means that is used for laser control, and thereby the mark detection means in the laser control system and the write strategy phase detection means in the phase detection/setting system can be commoditized, resulting in a reduction in the circuit scale.

### Embodiment 6

Hereinafter, an optical disc recording apparatus according to a sixth embodiment of the present invention will be described.

While the optical disc recording apparatuses according to the first to fifth embodiments correct the phase setting of the multipulse when the optical disc recording apparatus is powered on or reset, the optical disc recording apparatus of this sixth embodiment corrects the phase setting of the multipulse during the recording operation.

FIG. 28 is a block diagram illustrating the construction of an optical pickup in an optical disc recording apparatus according to the sixth embodiment. Since the laser control system 3, the phase detection/setting system 4, and the recording data generation system 5 in the optical disc recording apparatus according to the sixth embodiment are identical to those described for the first to fifth embodiment, these systems are omitted in FIG. 28.

In FIG. 28, 41 denotes an actuator for vertically moving a lens 40 to focus the lens 40 onto a recording layer of the optical disc 1. 42 denotes a focus driving circuit for driving the actuator 41 associated with the lens 40 to vertically move the lens 40, thereby focusing or defocusing the lens 40 onto the recording layer of the optical lens 1.

Next, a description will be given of the control operation to be performed when the phase setting is corrected during the recording operation in the optical disc recording apparatus according to the sixth embodiment.

In the state where the control for focusing the laser light on the recording layer of the optical disc 1 is carried out, when the average level corresponding to the time width of the duty ratio of the multipulse is measured with the voltage, since the emission power of the laser is a laser power for performing recording, the emitted light from the laser is undesirably recorded as data in the recording layer of the optical disc 1. When measurement is performed with all the phase settings being changed, the recorded data become insignificant data.

In this sixth embodiment, during the optical disc recording operation, the laser light is momentary defocused from the recording layer of the optical disc 1 by the focus driving circuit 42, and the average level of the multipulse is measured in this period. Thereby, the average level can be measured without performing recording onto the recording medium, and the phase setting of the set write strategy can be corrected by the same method as that described for the first embodiment.

Further, during the optical disc recording, the average level of the multipulse for a specific phase setting is measured in the state where the laser light is focused on the recording layer of the optical disc 1 by the focus driving circuit 42, and this measured value is compared with the ideal value, whereby abnormality of the optical disc recording apparatus can be detected. For example, if the difference between the measured value and the ideal value is significant, there is a possibility that a phase different from the phase setting might be outputted, and it is possible to judge that the apparatus is abnormal.

As described above, according to the optical disc recording apparatus of the sixth embodiment, while performing recording to the optical disc recording apparatus, the lens is defocused by the focus driving circuit, and the average level corresponding to the time width relating to the duty ratio of the multipulse is measured in this period. Therefore, it is possible to perform correction for the phase setting of the write strategy even when data are recorded in the recording medium.

Further, it is possible to confirm whether the set write strategy is correctly outputted or not by comparing the value that is measured when recording to the recording medium is performed, with the ideal value.

### Embodiment 7

Hereinafter, an optical disc recording apparatus according to a seventh embodiment of the present invention will be described.

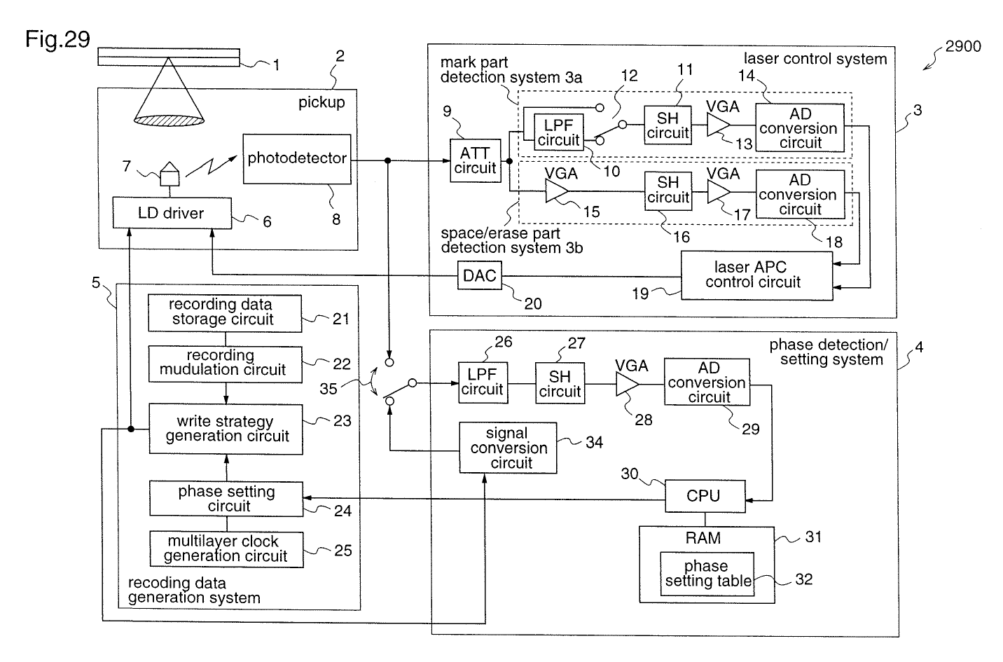

FIG. 29 is a block diagram illustrating the construction of an optical disc recording apparatus 2900 according to the seventh embodiment. In FIG. 29, 34 denotes a signal conversion circuit for converting the level of its output signal according to the output signal of the write strategy generator circuit 23. For example, when one signal level is transmitted by two differential signals as in the case where the output signal of the write strategy generator circuit 23 is a low-voltage differential signaling (LVDS) signal which is well used in recent years, it is necessary to convert the two differential signals into the original signal, and the signal conversion circuit 34 corresponds to this conversion circuit.

35 denotes a signal selector switch for switching the input to the LPF circuit 26 between the output signal from the photodetector 8 and the output signal from the signal conversion circuit 34. In FIG. 29, the same constituents as those shown in FIG. 1 are given the same reference numerals to omit the description thereof.

Hereinafter, a description will be given of the operation of the optical disc recording apparatus 2900 of the seventh embodiment in the case where the signal selector switch 35 selects the signal from the signal conversion circuit 34 as an input to the LPF circuit 26.

It is assumed that the output of signal conversion circuit 34 is outputted at a level from 0V to 3.3V. At this time, the binary signal from the write strategy generator circuit 23 is converted by the signal conversion circuit 34, and it is outputted at the level of 3.3V when the laser output is allowed while it is outputted at the level of 0V when the laser output is not allowed.

Since the output from the signal conversion circuit 34 is in the binarized state, if the range of the AD conversion circuit 29 is from 0V to 3.3V, the level to be detected by the AD conversion circuit 29 is detected at the level of 0V when the duty ratio of the multiples is 0%. On the other hand, when the duty ratio of the multipulse is 100%, the level to be detected by the AD conversion circuit 29 is detected at the level of 3.3V. Since the output of the signal conversion circuit 34 is binarized, when the phase setting of the write strategy is corrected by the same method similar as that described for the first embodiment, an ideal value can be obtained using a simplified ideal straight line ranging from 0V to 3.3V.

Further, the average level obtained by the LPF circuit 26 varies within the range from 0V to 3.3V according to the duty ratio. Therefore, it is possible to correct the phase setting of the multipulse by the same method as that described for the first embodiment, using the ideal value obtained from the ideal straight-line and the measured value which is obtained by averaging the output from the signal conversion circuit 34 with the LPF circuit 26 and then AD-converting the level.

Further, when performing correction of the phase setting by the method according to the sixth embodiment, since an actual laser emission is not required, the recording data generation system 5 and the phase detection/setting system 4 may be implemented as devices independent from the optical disc recording apparatus 2900, and the recording data generation system 5 may be operated by itself to perform the correction.

For example, assuming that the phase detection/setting system 4 is an inspection device and the recording data generation system 5 is an inspection target device, the phase detection/setting system 4 as the inspection device may perform measurement of the write strategy waveform outputted from the recording data generation system 5 and correction for the phase setting, thereby to output the values in the phase setting table 32.

Further, the optical disc recording apparatus 2900 according to the seventh embodiment may be provided with the SH position setting circuit 38 which can vary the SH position of the SH circuit 11 in the laser control system 3, and the phase detection system 4 may measure the average level of the multipulse part by using the mark part detection system 3a in the laser control system, like the optical disc recording apparatus 2500 according to the fifth embodiment shown in FIG. 25. In this case, the output of the signal conversion circuit 34 is input to the laser control system 3.

Further, in the optical disc recording apparatus according to the seventh embodiment, the S/N ratio may be improved by varying the setting of the VGA 28 in accordance with the resolution or range of the AD conversion circuit 29. Alternatively, the S/N ratio may be improved in accordance with the dynamic range of the detection system by varying the laser power. Further, more accurate detection may be performed by comparing the results of varying the setting of the VGA 28 or the laser power, respectively.

Furthermore, the optical disc recording apparatus 2900 according to the seventh embodiment has completely the same construction as that of the first embodiment when the signal selector switch 35 selects the output of the photodetector 8. Therefore, it is possible to obtain two kinds of results, i.e., the result obtained by correcting the laser output in accordance with the output of the photodetector 8 and the result obtained by correcting the laser output in accordance with the output of the write strategy generator circuit 23, and these results may be appropriately used according to the circumstances.

As described above, the optical disc recording apparatus according to the seventh embodiment of the present invention is constituted such that the pulse signal of the write strategy is directly averaged, and the time signal of the write strategy is directly converted into a voltage signal. Therefore, correction of the phase setting can be carried out based on the output of the write strategy setting circuit even when emission of laser is halted, irrespective of the laser control.

### Embodiment 8

Hereinafter, an optical disc recording apparatus according to an eighth embodiment of the present invention will be described.

The optical disc recording apparatus according to the eighth embodiment is constituted such that the duty ratio of the multipulse is corrected and the laser power is controlled using the corrected duty ratio in the optical disc recording apparatus according to the first embodiment.

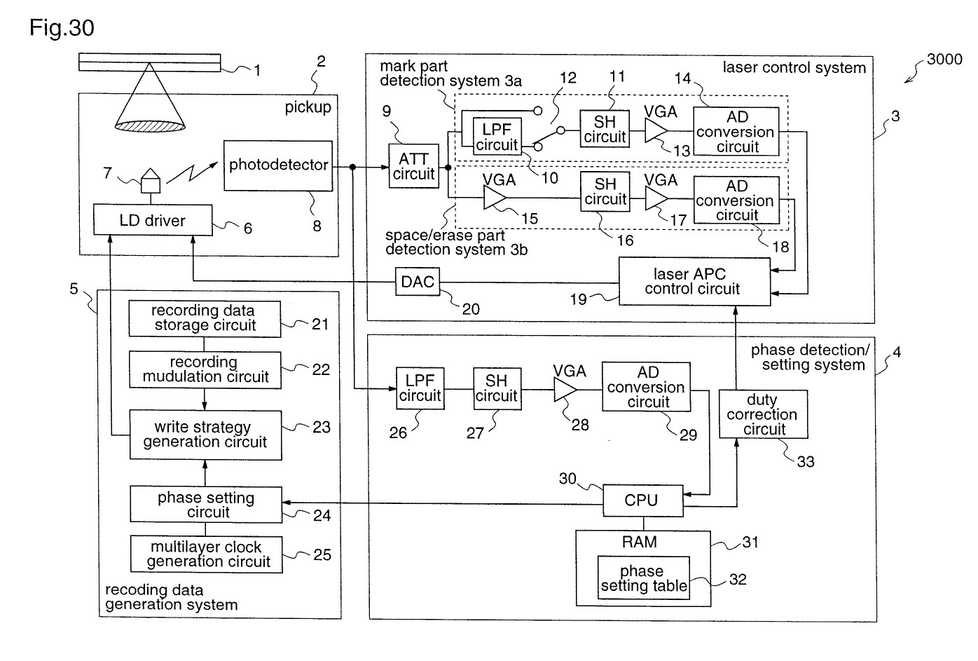

FIG. 30 is a block diagram illustrating the construction of an optical disc recording apparatus 3000 according to the eighth embodiment. In FIG. 30, a duty correction circuit 33 corrects the value of the duty ratio obtained from the phase setting value, on the basis of the output of the AD conversion circuit 29, and outputs the corrected value to the laser APC control circuit 19.

The laser APC control according to the first embodiment is performed as follows.

That is, in the case where the output of the photodetector 8 is a multipulse waveform, when performing calculation of a target power, conversion of a peak power is carried out based on the obtained average level and the duty ratio. For example, assuming that the duty ratio is 50% and the obtained average level is ave, the actually emitted peak power is calculated as ave/50%=ave×2. Since, in this calculation method, the multipulse waveform is averaged and the target power is calculated using the duty ratio of the multipulse, if the duty ratio calculated from the set phase setting deviates from the result obtained by voltage-converting the output of the LD 7 with the photodetector 8, the calculation of the target power deviates. For example, when the level of the average level ave=10 is measured, the level of 10×2=20 can be obtained with the duty ratio being 50%. Then, APC control is performed to obtain this level of 20.

When deviation of the duty ratio occurs in the actual waveform and the average level ave=12 is obtained, the level of 12×2=24 is detected, and the laser APC control circuit 19 performs power control to reduce the level of 24 to the level of 20. As the result, as the actual laser output, a smaller power with the ratio of 20/24 is outputted.

In this eighth embodiment, calculation is carried out with the duty ratio of 50%/(20/24)=about 60% while the ideal duty ratio is 50%, resulting in ave/60%=ave×1.67. Thereby, when the average level ave=12, the level of 12×1.67=about 20 can be obtained, and the actual laser output is not reduced.

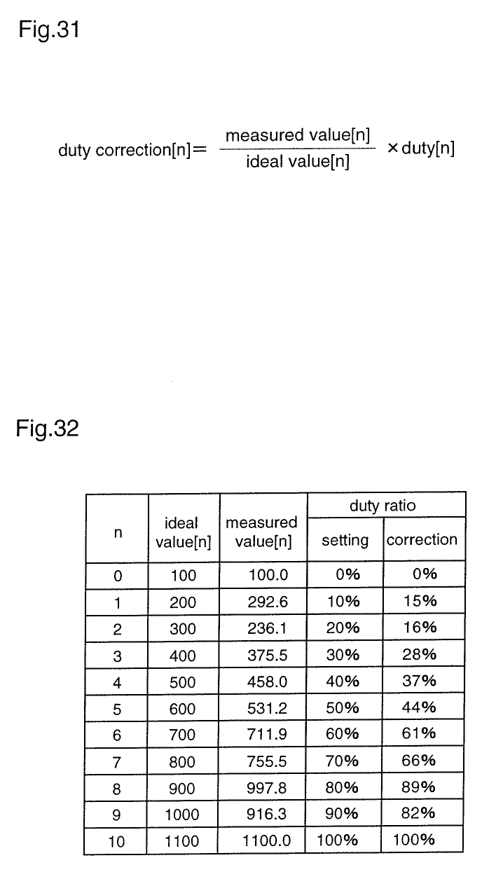

Hereinafter, a description will be given of the method of performing this duty correction in the optical disc recording apparatus 3000 according to the eighth embodiment, with reference to FIGS. 31 and 32.

With respect to the measured value [n] and ideal value [n] of the laser power shown in FIG. 10, the corrected duty ratio can be represented by a formula shown in FIG. 31. FIG. 32 shows the ideal value [n], the measured value [n], the setting of the duty ratio, and the result of the duty ratio corrected based on the formula shown in FIG. 31, with respect to the phase setting n. The phase setting n, ideal value [n], and measured value [n] are obtained by the same method as described in the first embodiment.

According to the result shown in FIG. 32, for example, when the phase setting n=5, the width of the multipulse is 0.5T, and the duty ratio should be 50%. However, from the result of the measured value [5], the corrected duty ratio obtained by the correction shown in FIG. 31 is 44%.

Although the target power of the laser should be originally calculated with the duty ratio of 50%, the calculation with the duty ratio of 50% has a possibility that a smaller power might be outputted from the laser APC control circuit 19. When the corrected duty ratio 44% is used, measured value[5]/44%×50%=531.2/0.44×0.5=603.6 is obtained, which is corrected to the state close to the ideal value[5]=600.

While the optical disc recording apparatus according to the eighth embodiment is obtained by adding the duty correction circuit 33 to the optical disc recording apparatus according to the first embodiment, the duty correction circuit 33 added in this eighth embodiment may be added to the optical disc recording apparatuses according to the second to seventh embodiments with the same effects as described above.

Further, in this eighth embodiment, the S/N ratio may be improved by varying the setting of the VGA 28 in accordance with the resolution or range of the AD conversion circuit 29. Alternatively, the S/N ratio may be improved according to the dynamic range of the detection system by varying the laser power. Further, more accurate detection may be performed by comparing the results of varying the setting of the VGA 28 or the laser power, respectively.

As described above, the optical disc recording apparatus according to the eighth embodiment of the present invention is constructed such that the duty ratio is corrected by the duty correction circuit, and the laser APC control is performed based on the corrected duty ratio. Therefore, power correction when performing laser control for the multipulse can be carried out.

### APPLICABILITY IN INDUSTRY

According to the present invention, it is possible to provide an optical disc recording apparatus which can perform optical recording with suppressing variations among different apparatuses.

1. An optical disc recording apparatus for recording a recording mark on the basis of a write strategy waveform comprising plural pulses, each pulse being shorter than the recording mark, comprising:
a write strategy generator circuit for generating the write strategy waveform;
a laser light source for emitting a laser light;
a laser driving circuit for driving the laser light source according to the pulse sequence of the write strategy waveform;
a photodetector for outputting a light intensity of the laser light emitted from the laser light source;
a laser power control circuit for controlling the light intensity of the laser light source by controlling the amount of current supplied from the laser driving circuit to the laser light source in accordance with a light intensity signal outputted from the photodetector;
an averaging circuit for averaging light intensity signals of a pulse sequence of a mark part, which is outputted from the photodetector, and outputting the result as an averaged level;
a sample/hold circuit for sampling and holding the output from the averaging circuit in the mark part;
a voltage measurement circuit for measuring the analog level held by the sample/hold circuit as a voltage value; and
a phase setting replacement circuit for setting a portion of the write strategy waveform to a multipulse comprising pulses of the same shape being repeated at predetermined intervals, fixing a phase setting of one pulse edge of the multipulse while successively varying a phase setting of the other pulse edge, obtaining an optimum phase setting which minimizes a phase error of pulse edges on a time axis which are actually outputted, on the basis of the measured value of the averaged level obtained by averaging the light intensity signals of the multipulse sequence of the mark part and an ideal value thereof, and changing the predetermined phase setting to the obtained phase setting.

2. An optical disc recording apparatus as defined in claim 1 wherein:
an output period of the multipulse is 1T which is a fundamental period of a mark/space length;
the phase setting replacement circuit varies the phase setting of the pulse edge of the multipulse from (r1)T to (r2)T (r1 is a real number within a range of 0≦r1≦1, r2 is a real number within a range of 0≦r2≦1, and r1<r2) to vary the duty ratio of the multipulse from (r1×100) % to (r2×100) %; and
the averaging circuit measures the averaged levels corresponding to the respective phase settings.

3. An optical disc recording apparatus as defined in claim 2 wherein:
the phase setting replacement circuit sets the (r1) and (r2) to r1=0 and r2=1, respectively, and varies the phase setting of the pulse edge of the multipulse from 0T to 1T to vary the duty ratio of the multipulse from 0% to 100%; and
the averaging circuit measures all the averaged levels which correspond to the respective phase settings.

4. An optical disc recording apparatus as defined in claim 1 wherein:
an output period of the multipulse is 2T which is twice as large as 1T which is a fundamental period of a mark/space length;
the phase setting replacement circuit varies the phase setting of the pulse edge of the multipulse from (r3)T to (r3+1)T (r3 is a real number within a range of 0≦r3≦1 to vary the duty ratio of the multipulse from (r3÷2×100) % to (r3+1)÷2×100) %; and
the averaging circuit measures the averaged levels corresponding to the respective phase settings.

5. An optical disc recording apparatus as defined in claim 4 wherein:
the phase setting replacement circuit sets the (r3) to r3=0.5, and varies the phase setting of the pulse edge of the multipulse from 0.5T to 1.5T to vary the duty ratio of the multipulse from 25% to 75%; and
the averaging circuit measures all the averaged levels which correspond to the respective phase settings.

6. An optical disc recording apparatus as defined in claim 1 wherein
the phase setting replacement circuit obtains the ideal value-using a straight line connecting an averaged level (y1) obtained when the duty ratio of the multipulse having the smallest phase setting is (x1) % and an averaged level (y2) obtained when the duty ratio of the multipulse having the largest phase setting is (x2) %, said straight line having an inclination of (y2−y1)+(x2−x1) and a contact of y1, and compares the ideal value with each measured value of the averaged level of the multipulse sequence obtained for each phase setting, and determines, as the optimum phase setting, the phase setting corresponding to the measured value which is closest to the ideal value, among the respective measured values.

7. An optical disc recording apparatus as defined in claim 1 further including:
a switching circuit for switching an output to the averaging circuit between an output of the photodetector, and an output of a standard signal generation device connected to the optical disc recording apparatus, which outputs a waveform signal equivalent to the write strategy waveform;
wherein the phase setting replacement circuit uses, as the ideal value, the averaged level which is obtained when the switching circuit selects the output of the standard signal generation device, and compares the ideal value with each measured value of the averaged level of the multipulse sequence obtained for each phase setting, which averaged level is obtained when the switching circuit selects the output of the photodetector, and determines, as the optimum phase setting, the phase setting corresponding to the measured value which is closest to the ideal value, among the respective measured values.

8. An optical disc recording apparatus as defined in claim 6 further including a judgment circuit for calculating an error between each measured value and the ideal value, and judges the optical disc recording apparatus as a defective when the error is large.

9. An optical disc recording apparatus as defined in claim 1 wherein the phase setting replacement circuit does not perform calculation of the optimum phase setting on a phase setting for which it is difficult to measure a voltage value corresponding to the time width of the duty ratio of the multipulse.

10. An optical disc recording apparatus for recording one recording mark in accordance with a write strategy waveform comprising one block pulse, comprising:
a write strategy generator circuit for generating the write strategy waveform;
a laser light source for emitting a laser light;
a laser driving circuit for driving the laser light source in accordance with a pulse sequence of the write strategy waveform;
a photodetector for outputting a light intensity of the laser light emitted from the laser light source;
a laser power control circuit for controlling the light intensity of the laser light source by controlling the amount of current supplied from the laser driving circuit to the laser light source in accordance with the light intensity signal outputted from the photodetector;
an averaging circuit for averaging light intensity signals of a pulse sequence of a mark part, which is outputted from the photodetector, and outputting the result as an averaged level;
a sample/hold circuit for sampling and holding the output of the averaging circuit in the mark part;
a voltage measurement circuit for measuring the analog level that is held by the sample/hold circuit, as a voltage value; and
a phase setting replacement circuit for setting a portion of the write strategy waveform to a block pulse—which forms a recording mark by a pulse, fixing a phase setting of one pulse edge of the block pulse while successively varying a phase setting of the other pulse edge of the block pulse, obtaining an optimum phase setting which minimizes a phase error of pulse edges of a time axis that are actually outputted, on the basis of the measured value of the averaged level obtained by averaging the light intensity signals of the block pulse sequence of the mark part and an ideal value thereof, and changing the predetermined phase setting to the obtained phase setting.

11. An optical disc recording apparatus as defined in claim 1 further including:
a hold control circuit for halting the laser control by the laser power control circuit; and
a sample position setting circuit for moving a sample position of the averaged level in the sample/hole circuit to a predetermined position; wherein
the laser power control circuit controls the light intensity of the laser light source on the basis of the output of the voltage measurement circuit;
when the laser power control circuit performs laser control, the sample position setting circuit moves the sample position to a top pulse portion of the mark part; and
when the phase setting replacement circuit varies the phase setting, the sample position setting circuit moves the sample position to a multipulse portion of the mark part, and the hold control circuit holds the laser control.

12. An optical disc recording apparatus as defined in claim 1 further including a voltage gain amplifier for arbitrarily controlling the voltage level of the output signal from the sample/hold circuit.

13. An optical disc recording apparatus as defined in claim 1 wherein the laser power control circuit performs plural times of laser power control with changing the laser emission power level, and controls the light intensity of the laser light source with a laser power having the highest precision of laser power control.

14. An optical disc recording apparatus as defined in claim 1 wherein, while focusing onto the optical disc deviates, the phase setting replacement circuit successively varies the phase setting, and the averaging circuit measures the averaged level by averaging the light intensity signal of the multipulse sequence of the mark part for each phase setting.

15. An optical disc recording apparatus as defined in claim 1 wherein the averaging circuit directly averages the pulse signal of the write strategy waveform that is outputted from the write strategy generator circuit, and outputs the result as the averaged level.

16. An optical disc recording apparatus as defined in claim 15 further including a switching circuit for switching an output to the averaging circuit between the output of the photodetector and the output of the write strategy generator circuit.

17. An optical disc recording apparatus as defined in claim 6 further including
a duty correction circuit for correcting the setting of the duty rate of the multipulse on the basis of the ideal value and the measured value; and
the laser power control circuit performing a peak power conversion calculation on the basis of the output of the voltage measurement circuit and the corrected duty ratio.

18. An optical disc recording apparatus as defined in claim 1 further including a nonvolatile memory for holding values of correction parameters that are calculated by the phase setting replacement circuit.

19. An optical disc recording apparatus as defined in claim 7 further including a judgment circuit for calculating an error between each measured value and the ideal value, and judges the optical disc recording apparatus as a defective when the error is large.

20. An optical disc recording apparatus as defined in claim 10 further including a voltage gain amplifier for arbitrarily controlling the voltage level of the output signal from the sample/hold circuit.

21. An optical disc recording apparatus as defined in claim 10 wherein the laser power control circuit performs plural times of laser power control with changing the laser emission power level, and controls the light intensity of the laser light source with a laser power having the highest precision of laser power control.

22. An optical disc recording apparatus as defined in claim 10 wherein, while focusing onto the optical disc deviates, the phase setting replacement circuit successively varies the phase setting, and the averaging circuit measures the averaged level by averaging the light intensity signal of the multipulse sequence of the mark part for each phase setting.

23. An optical disc recording apparatus as defined in claim 10 wherein the averaging circuit directly averages the pulse signal of the write strategy waveform that is outputted from the write strategy generator circuit, and outputs the result as the averaged level.

24. An optical disc recording apparatus as defined in claim 7 further including
a duty correction circuit for correcting the setting of the duty rate of the multipulse on the basis of the ideal value and the measured value; and
the laser power control circuit performing a peak power conversion calculation on the basis of the output of the voltage measurement circuit and the corrected duty ratio.

25. An optical disc recording apparatus as defined in claim 10 further including a nonvolatile memory for holding values of correction parameters that are calculated by the phase setting replacement circuit.
